(19) United States
(12) Patent Application Publication
(10) Pub. No.: US 2025/0046310 A1
(43) Pub. Date: Feb. 6, 2025

(54) VOICE ACTIVATED DEVICE FOR USE WITH A VOICE-BASED DIGITAL ASSISTANT

(71) Applicant: Apple Inc., Cupertino, CA (US)

(72) Inventor: Kevin MILDEN, San Jose, CA (US)

(21) Appl. No.: 18/923,460

(22) Filed: Oct. 22, 2024

Related U.S. Application Data
(63) Continuation of application No. 18/220,769, filed on Jul. 11, 2023.
Application No. 18/220,769 is a continuation of application No. 16/987,005, filed on Aug. 6, 2020, now Pat. No. 11,798,547.
Application No. 16/987,005 is a continuation of application No. 14/205,104, filed on Mar. 11, 2014, now Pat. No. 10,748,529.
(60) Provisional application No. 61/799,722, filed on Mar. 15, 2013.

(51) Int. Cl. G10L 15/22; G06F 3/16

(52) U.S. Cl. CPC G10L 15/22; G06F 3/167

(57) ABSTRACT

A voice activated device for interaction with a digital assistant is provided. The device comprises a housing, one or more processors, and memory, the memory coupled to the one or more processors and comprising instructions for automatically identifying and connecting to a digital assistant server. The device further comprises a power supply, a wireless network module, and a human-machine interface. The human-machine interface consists essentially of: at least one speaker, at least one microphone, an ADC coupled to the microphone, a DAC coupled to the at least one speaker, and zero or more additional components selected from the set consisting of: a touch-sensitive surface, one or more cameras, and one or more LEDs. The device is configured to act as an interface for speech communications between the user and a digital assistant of the user on the digital assistant server.

### CROSS-REFERENCE TO RELATED APPLICATIONS

This application claims the benefit of U.S. Provisional Application No. 61/799,722, filed on Mar. 15, 2013, entitled VOICE ACTIVATED DEVICE FOR USE WITH A VOICE-BASED DIGITAL ASSISTANT, which is hereby incorporated by reference in its entity for all purposes.

### TECHNICAL FIELD

The disclosed implementations relate generally to voice-based digital assistants. More specifically, it relates to a voice activated device for interacting with a voice-based digital assistant.

### BACKGROUND

Recently, voice-based digital assistants have been introduced into the marketplace to handle various tasks such as web searching and navigation. One advantage of such voice-based digital assistants is that users can interact with a device in a hands-free manner without handling or even looking at the device. Hands-free operation can be particularly beneficial when a person cannot or should not physically handle a device, such as when they are cooking. Accordingly, it would be advantageous to provide a voice-activated device for interacting with a voice-based digital assistant (or other speech-based service).

### SUMMARY

The implementations described below provide voice activated devices for interacting with a voice-based assistant. Interactions with a voice-based digital assistant (or other speech-based services, such as a speech-to-text transcription service) can be performed using only an audio interface on the user device. Thus, it is advantageous to limit the human-machine interface on the device to conserve power, reduce production costs, and/or reduce the size of the device. As described herein, a voice activated device with a human-machine interface consisting essentially of an audio interface can be used to interact with a speech-based service without requiring any physical interaction by the user. For example, a user is enabled to activate a digital assistant on the voice activated device by reciting the phrase “Hey, Assistant.” In response, the voice activated device outputs a beep, sound, or speech output (e.g., “what can I do for you?”) indicating to the user that the listening mode is active. Accordingly, the user can initiate an interaction with the voice-based digital assistant without having to physically touch the voice activated device.

One technique for initiating a speech-based service with a voice trigger is to have the speech-based service continuously listen for a predetermined trigger word, phrase, or sound (any of which may be referred to herein as “the trigger sound”). However, continuously operating the speech-based service (e.g., the voice-based digital assistant) requires substantial audio processing and battery power. In order to reduce the power consumed by providing voice trigger functionality, several techniques are, optionally, employed. In some implementations, the main processor of the voice activated device (e.g., an “application processor”) is kept in a low-power or un-powered state while one or more sound detectors that use less power (e.g., because they do not rely on the application processor) remain active. (When it is in a low-power or un-powered state, an application processor or any other processor, program, or module may be described as being inactive or in a standby mode.) For example, a low-power sound detector is used to monitor an audio channel for a trigger sound even when the application processor is inactive. This sound detector is sometimes referred to herein as a trigger sound detector. In some implementations, the trigger sound detector is configured to detect particular sounds, phonemes, and/or words. The trigger sound detector (including hardware and/or software components) is designed to recognize specific words, sound, or phrases, but is generally not capable of or optimized for providing full speech-to-text functionality, as such tasks require greater computational and power resources. Thus, in some implementations, the trigger sound detector recognizes whether a voice input includes a predefined pattern (e.g., a sonic pattern matching the words “Hey, Assistant”), but is not able to (or is not configured to) convert the voice input into text or recognize a significant amount of other words. Once the trigger sound has been detected, then, the voice-based digital assistant is brought out of a standby mode so that the user can provide a voice command.

In some implementations, the trigger sound detector is configured to detect several different trigger sounds, such as a set of words, phrases, sounds, and/or combinations thereof. The user can then use any of those sounds to initiate the speech-based service. In one example, a voice trigger is preconfigured to respond to the phrases “Hey, Assistant,” “Wake up, Assistant,” “Invoke my digital assistant,” or “Hello, HAL, do you read me, HAL?” In some implementations, the user must select one of the preconfigured trigger sounds as the sole trigger sound. In some implementations, the user selects a subset of the preconfigured trigger sounds, so that the user can initiate the speech-based service with different trigger sounds. In some implementations, all of the preconfigured trigger sounds remain valid trigger sounds.

In some implementations, another sound detector is used so that even the trigger sound detector can be kept in a low-power or no-power mode for much of the time. For example, a different type of sound detector (e.g., one that uses less power than the trigger sound detector) is used to monitor an audio channel to determine whether the sound input corresponds to a certain type of sound. Sounds are categorized as different “types” based on certain identifiable characteristics of the sounds. For example, sounds that are of the type “human voice” have certain spectral content, periodicity, fundamental frequencies, etc. Other types of sounds (e.g., whistles, hand claps, etc.) have different characteristics. Sounds of different types are identified using audio and/or signal processing techniques, as described herein.

This sound detector is sometimes referred to herein as a sound-type detector.” For example, if a predetermined trigger phrase is “Hey, Assistant,” the sound-type detector determines whether the input likely corresponds to human speech. If the trigger sound is a non-voiced sound, such as a whistle, the sound-type detector determines whether a sound input likely corresponds to a whistle. When the appropriate type of sound is detected, the sound-type detector initiates the trigger sound detector to further process and/or analyze the sound. And because the sound-type detector requires less power than the trigger sound detector (e.g., because it uses circuitry with lower power demands and/or more efficient audio processing algorithms than the trigger-sound detector), the voice trigger functionality consumes even less power than with a trigger sound detector alone.

In some implementations, yet another sound detector is used so that both the sound-type detector and the trigger sound detector described above can be kept in a low-power or no-power mode for much of the time. For example, a sound detector that uses less power than the sound-type detector is used to monitor an audio channel to determine whether a sound input satisfies a predetermined condition, such as an amplitude (e.g., volume) threshold. This sound detector may be referred to herein as a noise detector. When the noise detector detects a sound that satisfies the predetermined threshold, the noise detector initiates the sound-type detector to further process and/or analyze the sound. And because the noise detector requires less power than either the sound-type detector or the trigger sound detector (e.g., because it uses circuitry with lower power demands and/or more efficient audio processing algorithms), the voice trigger functionality consumes even less power than the combination of the sound-type detector and the trigger sound detector without the noise detector.

In some implementations, any one or more of the sound detectors described above are operated according to a duty cycle, where they are cycled between “on” and “off” states. This further helps to reduce power consumption of the voice trigger. For example, in some implementations, the noise detector is “on” (i.e., actively monitoring an audio channel) for 10 milliseconds, and “off” for the following 90 milliseconds. This way, the noise detector is “off” 90% of the time, while still providing effectively continuous noise detection functionality. In some implementations, the on and off durations for the sound detectors are selected so that all of the detectors are be activated while the trigger sound is still being input. For example, for a trigger phrase of “Hey, Assistant,” the sound detectors are, optionally, configured so that no matter where in the duty cycle(s) the trigger phrase begins, the trigger sound detector is activated in time to analyze a sufficient amount of the input. For example, the trigger sound detector will be activated in time to receive, process, and analyze the sounds “ay Assistant,” which is enough to determine that the sound matches the trigger phrase. In some implementations, sound inputs are stored in memory as they are received and passed to au upstream detector so that a larger portion of the sound input can be analyzed. Accordingly, even if the trigger sound detector is not initiated until after a trigger phrase has been uttered, it can still analyze the entire recorded trigger phrase.

Some implementations provide a voice activated device for interacting with a voice based digital assistant. The voice activated device includes a housing, one or more processors in the housing, memory in the housing, the memory coupled to the one or more processors and comprising instructions for automatically identifying and connecting to a digital assistant server without a user having to enter information about the server. The voice activated device also includes a power supply at least partially within the housing, a wireless network module at least partially within the housing, the wireless network module coupled to the one or more processors, and a human-machine interface. The human-machine interface consists essentially of at least one speaker at least partially within the housing, at least one microphone at least partially within the housing, an analog to digital converter coupled to the microphone and configured to convert speech into digital signals, a digital to analog converter coupled to the at least one speaker and configured to convert received data into audio signals, including speech, and zero or more additional components, coupled to the one or more processors, selected from the set consisting of: a touch-sensitive surface configured to receive touch inputs; one or more cameras; and one or more LEDs. The voice activated device is configured to act as an interface for speech communications between the user and a digital assistant of the user on the digital assistant server.

In some implementations, the touch-sensitive surface corresponds to the housing. In some implementations, the touch-sensitive surface corresponds to a portion of the housing. In some implementations, the touch-sensitive surface replaces a portion of the housing.

In some implementations, the wireless network module is configured to utilize any known wireless network protocol such as Bluetooth, Wi-Fi, voice over Internet Protocol (VoIP), infrared, or any other suitable communication protocol. In some implementations, the wireless network module is further configured to couple to one or more user devices.

In some implementations, the voice activated device is coupled with one or more additional instances of the voice activated device via a wireless network and the voice activated device shares information with the one or more additional instances of the voice activated device. In some implementations, the voice activated device is further configured to provide intercom communication between the one or more coupled devices.

In some implementations, the LEDs are configured to provide user feedback. In some implementations, the LEDs are configured to indicate the voice activated device's current state.

In some implementations, the voice activated device also includes one or more light sensors coupled to the one or more processors. In some implementations, the voice activated device also includes a motion sensor to detect motion in proximity to the voice activated device.

In some implementations, the voice activated device is further configured, while in a security mode, to: detect a change in light level above a predefined threshold with the one or more light sensors; in response to the change in light level, audibly request a passcode; in accordance with a determination that the passcode was received within a predetermined amount of time and that the received passcode matches a preset security code, disable the security mode; and in accordance with a determination that the passcode was not received within a predetermined amount of time or that the received passcode did not match the preset security code, activate an alarm routine.

In some implementations, the voice activated device is further configured, while in a security mode, to: detect movement with the motion sensor; in response to the detected movement, audibly request a passcode; in accordance with a determination that the passcode was received within a predetermined amount of time and that the received passcode matches a preset security code, disable the security mode; and in accordance with a determination that the passcode was not received within a predetermined amount of time or that the received passcode did not match the preset security code, activate an alarm routine.

In some implementations, the voice activated device also includes a fire detection module coupled to the one or more processors. In some implementations, the voice activated device also includes a carbon monoxide detection module coupled to the one or more processors.

In some implementations, the memory stores a personalized configuration for each of a plurality of users, and the voice activated device is further configured, when activated by a respective user, to provide services to the respective user utilizing the respective personalized configuration.

In some implementations, the voice activated device is further configured to play audio files associated with the user. In some implementations, the voice activated device is further configured for home automation. In some implementations, the voice activated device is further configured to function as a timer when prompted by the user. In some implementations, the voice activated device is further configured to access a news source and provide news to the user when prompted by the user. In some implementations, the voice activated device is further configured to store the converted user speech in memory when prompted by the user.

In some implementations, the voice activated device is further configured to provide text-to-speech (TTS) communication between the user and a second party. In some implementations, the voice activated device is coupled to a telephone associated with the user and the voice activated device is further configured to provide telecommunication via the telephone for the user. In some implementations, the voice activated device is further configured to provide notifications received from the one or more coupled devices to the user.

In some implementations, the voice activated device is further configured to access the user's calendar. In some of these implementations, the voice activated device is further configured to provide calendar reminders to the user. In some implementations, the voice activated device is further configured to update the user's calendar.

In some implementations, the voice activated device is further configured to access a set of instructions and output the instruction steps when prompted by the user.

In some implementations, the voice activated device is further configured to store in memory one or more macros provided by the user, where each macro is associated with a respective phrase. In some of these implementations, the voice activated device is further configured to play the macro associated with the respective phrase when the respective phrase is spoken by the user.

### BRIEF DESCRIPTION OF THE DRAWINGS

FIG. 1 is a block diagram illustrating an environment in which a digital assistant operates in accordance with some implementations.

FIG. 2 is a block diagram illustrating a voice activated device in accordance with some implementations.

FIG. 3A is a block diagram illustrating a standalone digital assistant system or a digital assistant server system in accordance with some implementations.

FIG. 3B is a block diagram illustrating functions of the digital assistant shown in FIG. 3A in accordance with some implementations.

FIG. 3C is a network diagram illustrating a portion of an ontology in accordance with some implementations.

FIG. 4 is a block diagram illustrating components of an audio subsystem, in accordance with some implementations.

FIGS. 5-6 are flow charts illustrating methods for a voice activated device operating in a security mode, in accordance with some implementations.

Like reference numerals refer to corresponding parts throughout the drawings.

### DESCRIPTION OF IMPLEMENTATIONS

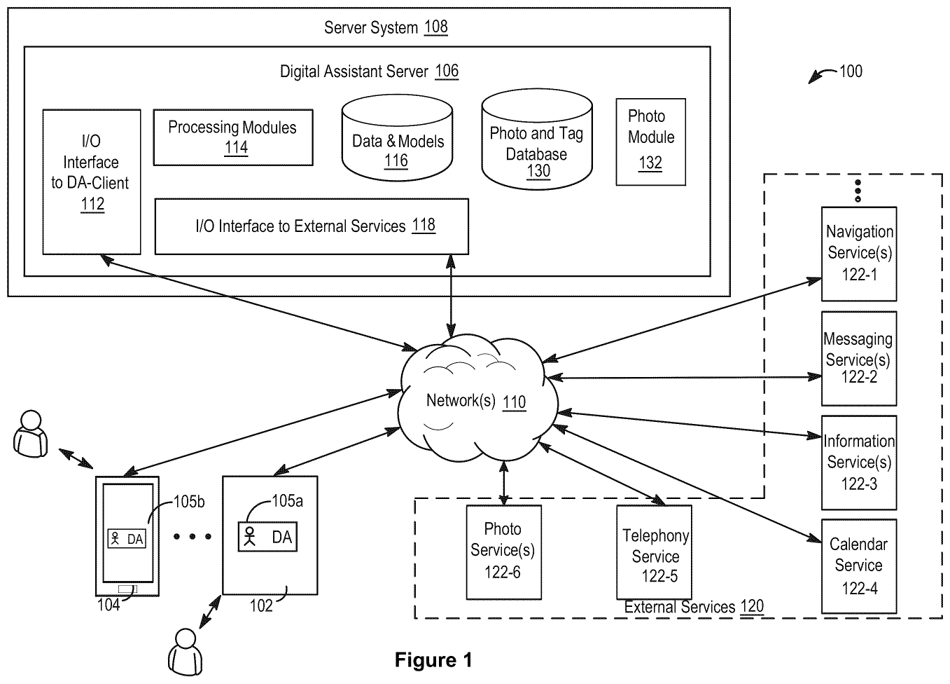

FIG. 1 is a block diagram of an operating environment 100 of a digital assistant according to some implementations. The terms “digital assistant,” “virtual assistant,” “intelligent automated assistant,” “voice-based digital assistant,” or “automatic digital assistant,” refer to any information processing system that interprets natural language input in spoken and/or textual form to deduce user intent (e.g., identify a task type that corresponds to the natural language input), and performs actions based on the deduced user intent (e.g., perform a task corresponding to the identified task type). For example, to act on a deduced user intent, the system can perform one or more of the following: identifying a task flow with steps and parameters designed to accomplish the deduced user intent (e.g., identifying a task type), inputting specific requirements from the deduced user intent into the task flow, executing the task flow by invoking programs, methods, services, APIs, or the like (e.g., sending a request to a service provider); and generating output responses to the user in an audible (e.g., speech) and/or visual form.

Specifically, once initiated, a digital assistant system is capable of accepting a user request at least partially in the form of a natural language command, request, statement, narrative, and/or inquiry. Typically, the user request seeks either an informational answer or performance of a task by the digital assistant system. A satisfactory response to the user request is generally either provision of the requested informational answer, performance of the requested task, or a combination of the two. For example, a user may ask the digital assistant system a question, such as “Where am I right now?” Based on the user's current location, the digital assistant may answer, “You are in Central Park near the west gate.” The user may also request the performance of a task, for example, by stating “Please invite my friends to my girlfriend's birthday party next week.” In response, the digital assistant may acknowledge the request by generating a voice output, “Yes, right away,” and then send a suitable calendar invite from the user's email address to each of the user' friends listed in the user's electronic address book or contact list. There are numerous other ways of interacting with a digital assistant to request information or performance of various tasks. In addition to providing verbal responses and taking programmed actions, the digital assistant can also provide responses in other visual or audio forms (e.g., as text, alerts, music, videos, animations, etc.).

As shown in FIG. 1, in some implementations, a digital assistant system is implemented according to a client-server model. The digital assistant system includes a client-side portion (e.g., 105a and 105b) (hereafter “digital assistant (DA) client 105”) executed on a user device (e.g., 104 and 102), and a server-side portion 106 (hereafter “digital assistant (DA) server 106”) executed on a server system 108. The DA client 105 communicates with the DA server 106 through one or more networks 110. The DA client 105 provides client-side functionalities such as user input and output processing and communications with the DA server 106. The DA server 106 provides server-side functionalities for any number of DA clients 105 each residing on a respective user device (also called a client device or electronic device).

In some implementations, the DA server 106 includes a client-facing I/O interface 112, one or more processing modules 114, data and models 116, an I/O interface to external services 118, a photo and tag database 130, and a photo-tag module 132. The client-facing I/O interface facilitates the client-facing input and output processing for the digital assistant server 106. The one or more processing modules 114 utilize the data and models 116 to determine the user's intent based on natural language input and perform task execution based on the deduced user intent. Photo and tag database 130 stores fingerprints of digital photographs, and, optionally digital photographs themselves, as well as tags associated with the digital photographs. Photo-tag module 132 creates tags, stores tags in association with photographs and/or fingerprints, automatically tags photographs, and links tags to locations within photographs.

In some implementations, the DA server 106 communicates with external services 120 (e.g., navigation service(s) 122-1, messaging service(s) 122-2, information service(s) 122-3, calendar service 122-4, telephony service 122-5, photo service(s) 122-6, etc.) through the network(s) 110 for task completion or information acquisition. The I/O interface to the external services 118 facilitates such communications.

Examples of the user device 104 include, but are not limited to, a handheld computer, a personal digital assistant (PDA), a tablet computer, a laptop computer, a desktop computer, a cellular telephone, a smartphone, an enhanced general packet radio service (EGPRS) mobile phone, a media player, a navigation device, a game console, a television, a remote control, or a combination of any two or more of these data processing devices or any other suitable data processing devices.

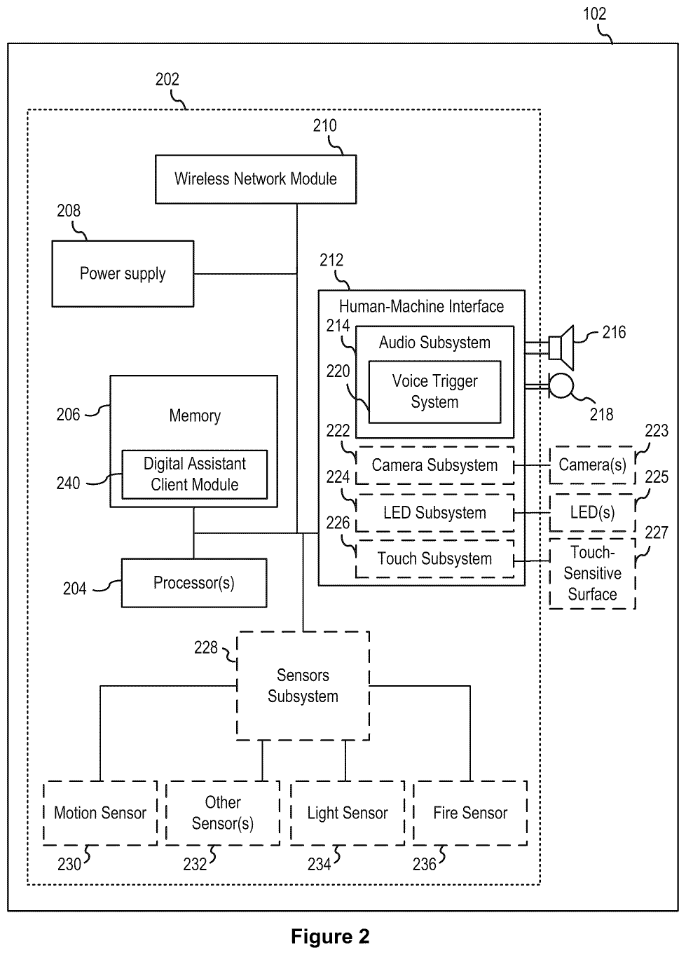

More details on a voice activated device are provided in reference to an exemplary voice activated device 102 shown in FIG. 2.

Examples of the communication network(s) 110 include local area networks (LAN) and wide area networks (WAN), e.g., the Internet. The communication network(s) 110 may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

The server system 108 can be implemented on at least one data processing apparatus and/or a distributed network of computers. In some implementations, the server system 108 also employs various virtual devices and/or services of third party service providers (e.g., third-party cloud service providers) to provide the underlying computing resources and/or infrastructure resources of the server system 108.

Although the digital assistant system shown in FIG. 1 includes both a client-side portion (e.g., the DA client 105) and a server-side portion (e.g., the DA server 106), in some implementations, a digital assistant system refers only to the server-side portion (e.g., the DA server 106). In some implementations, the functions of a digital assistant can be implemented as a standalone application installed on a user device. In addition, the divisions of functionalities between the client and server portions of the digital assistant can vary in different implementations. For example, in some implementations, the DA client 105 is a thin-client that provides only user-facing input and output processing functions, and delegates all other functionalities of the digital assistant to the DA server 106. In some other implementations, the DA client 105 is configured to perform or assist one or more functions of the DA server 106.

FIG. 2 is a block diagram of a voice activated device in accordance with some implementations. Voice activated device 102 includes housing 202, one or more processors 204, memory 206, power supply 208, wireless network module 210, and human-machine interface 212. The various components in voice activated device 102 are coupled by one or more communication buses or signal lines. Voice activated device 102, optionally, includes sensors subsystem 228 and various sensors that are coupled to sensors subsystem 228. The sensors gather information and/or facilitate various functionalities of voice activated device 102. For example, in some implementations, a motion sensor 230, a light sensor 234, a fire sensor 236, and other sensors 232 including a GPS receiver, a temperature sensor, and a proximity sensor are coupled to the sensors subsystem 228 to facilitate light, location, safety, security, and proximity sensing functions. In some implementations, other sensors 232 include a biometric sensor, a barometer, and the like, and are connected to the sensors subsystem 228, to facilitate related functionalities.

In some implementations, human-machine interface 212 includes audio subsystem 214 coupled to one or more speakers 216 and one or more microphones 218. In some implementations, human-machine interface 212 includes camera subsystem 222 connected to one or more cameras 223. In some of these implementations, camera subsystem 222 facilitates security and communications functionalities (e.g., such as taking photographs and recording video clips). In some implementations, human-machine interface 212 includes LED subsystem 224 connected to one or more LEDs 225. In some of these implementations, LED subsystem 224 facilitates user feedback functionalities. In some implementations, human-machine interface 212 includes touch subsystem 226 connected to a touch-sensitive surface 227. In some of these implementations, touch subsystem 226 facilitates user input functionalities.

Wireless network module 210 optionally includes radio frequency receivers and transmitters and/or optical (e.g., infrared) receivers and transmitters. When voice activated device 102 includes touch subsystem 226 and the touch-sensitive surface 227, touch subsystem 226 and the touch-sensitive surface 227 are typically configured to, for example, detect contact and movement or break thereof using any of a plurality of touch sensitivity technologies, such as capacitive, resistive, infrared, surface acoustic wave technologies, proximity sensor arrays, and the like.

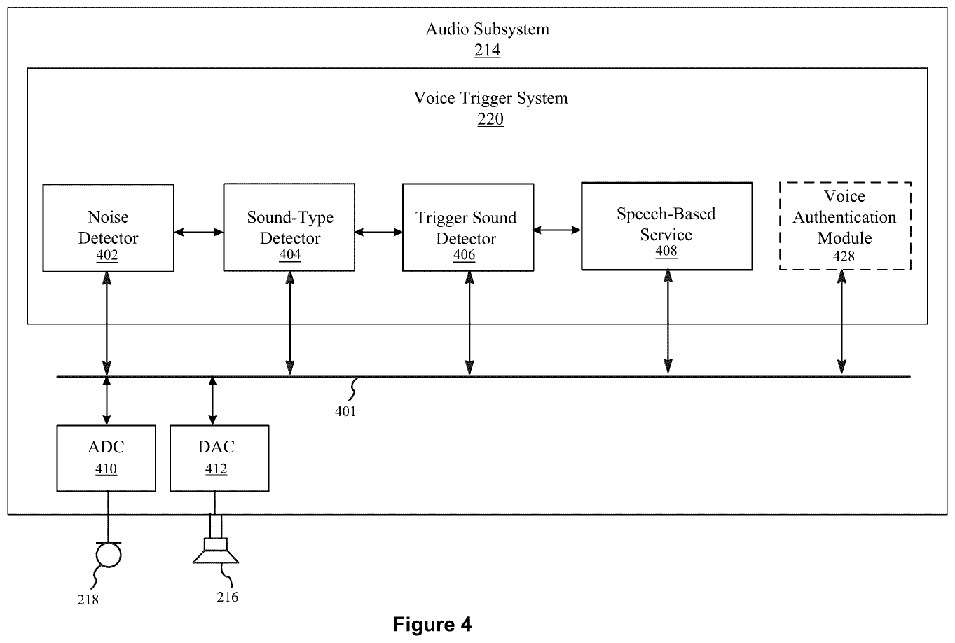

In some implementations, audio subsystem 214 is coupled to one or more speakers 216 and one or more microphones 218 to facilitate voice-enabled functions, such as voice recognition, voice replication, digital recording, and telephony functions. In some implementations, audio subsystem 214 includes voice trigger system 220. In some implementations, voice trigger system 220 and/or the audio subsystem 214 includes low-power audio circuitry and/or programs (e.g., including hardware and/or software) for receiving and/or analyzing sound inputs, including, for example, one or more analog-to-digital converters, digital signal processors (DSPs), sound detectors, memory buffers, codecs, and the like. In some implementations, the low-power audio circuitry (alone or in addition to other components of voice activated device 102) provides voice (or sound) trigger functionality for one or more aspects of voice activated device 102, such as a voice-based digital assistant or other speech-based service. In some implementations, the low-power audio circuitry provides voice trigger functionality even when other components of voice activated device 102 are shut down and/or in a standby mode, such as the processor(s) 204, memory 206, and the like. Voice trigger system 220 is described in further detail with respect to FIG. 4.

In some implementations, memory 206 includes a non-transitory computer readable storage medium, such as high-speed random access memory and/or non-volatile memory (e.g., one or more magnetic disk storage devices, one or more flash memory devices, one or more optical storage devices, and/or other non-volatile solid-state memory devices).

In some implementations, memory 206 stores an operating system, a communications module, a sensor processing module, and applications, and a subset or superset thereof. The operating system includes instructions for handling basic system services and for performing hardware dependent tasks. The communications module facilitates communicating with one or more additional devices, one or more computers and/or one or more servers. The sensor processing module facilitates sensor-related processing and functions (e.g., processing voice input received with the one or more microphones 218). The application module facilitates various functionalities of user applications, such as electronic-messaging, web browsing, media processing, and/or other processes and functions. In some implementations, voice activated device 102 stores in memory 206 one or more software applications each associated with at least one of the external service providers.

As described above, in some implementations, memory 206 also stores client-side digital assistant instructions (e.g., in a digital assistant client module 240) and various user data (e.g., user-specific vocabulary data, preference data, and/or other data such as the user's electronic address book or contact list, to-do lists, shopping lists, etc.) to provide the client-side functionalities of the digital assistant.

In various implementations, digital assistant client module 240 is capable of accepting voice input, touch input, and/or visual input through human-machine interface 212 of voice activated device 102. Digital assistant client module 240 is also capable of providing output in audio and visual forms. For example, output can be provided as voice, sound, alerts, and/or combinations of two or more of the above. During operation, digital assistant client module 240 optionally communicates with the digital assistant server (e.g., the digital assistant server 106, FIG. 1) using wireless network module 210. In some implementations, digital assistant client module 240 corresponds to DA client 105 (e.g., FIG. 1).

In some implementations, the digital assistant client module 240 utilizes various sensors and subsystems to gather additional information from the surrounding environment of voice activated device 102 to establish a context associated with a user input. In some implementations, the digital assistant client module 240 provides the context information or a subset thereof with the user input to the digital assistant server (e.g., the digital assistant server 106, FIG. 1) to help deduce the user's intent.

In some implementations, the context information that can accompany the user input includes sensor information, e.g., lighting, ambient noise, ambient temperature, images or videos of the surrounding environment, etc. In some implementations, the context information also includes the physical state of the voice activated device, e.g., device orientation, device location, device temperature, power level, speed, wireless signals strength, etc. In some implementations, information related to the software state of voice activated device 102, e.g., running processes, installed programs, past and present network activities, background services, error logs, resources usage, etc., of voice activated device 102 is also provided to the digital assistant server (e.g., the digital assistant server 106, FIG. 1) as context information associated with a user input.

In some implementations, the DA client module 240 selectively provides information (e.g., at least a portion of the user data) stored on voice activated device 102 in response to requests from the digital assistant server. In some implementations, the digital assistant client module 240 also elicits additional input from the user via a natural language dialogue upon request by the digital assistant server 106 (FIG. 1). The digital assistant client module 240 passes the additional input to the digital assistant server 106 to help the digital assistant server 106 in intent deduction and/or fulfillment of the user's intent expressed in the user request.

In some implementations, memory 206 includes additional instructions or fewer instructions. Furthermore, various functions of the voice activated device 102 are, optionally, implemented in hardware and/or in firmware, including in one or more signal processing and/or application specific integrated circuits. Thus, in some implementations, the voice activated device 102 includes fewer modules and/or applications than those illustrated in FIG. 2.

In some embodiments, voice activated device 102 does not include any physical ports (e.g., all communication between voice activated device 102 and external networks occurs via wireless communications, including communications related to software updates, communications related to performing voice commands received from a user, communications to and from other user devices, and the like). In embodiments, where the voice activated device does not include any physical ports, the lack of physical ports improves the appearance and functionality of the voice activated device, by making the voice activated device less susceptible to physical damage and allowing for a more symmetrical and visually pleasing appearance. Additionally, having fewer components reduces the manufacturing cost and the price of voice activated device 102.

Some embodiments provide a voice activated device (e.g., device 102) for interacting with a voice based digital assistant. The voice activated device includes a housing (e.g., housing 202), one or more processors (e.g., processor(s) 204) in the housing, memory (e.g., memory 206) in the housing, the memory coupled to the one or more processors and comprising instructions for automatically identifying and connecting to a digital assistant server without a user having to enter information about (e.g., an internet address for) the server.

The voice activated device also includes a power supply (e.g., a transformer or a battery such as power supply 208) at least partially within the housing (e.g., with a fold-out plug), a wireless network module (e.g., wireless network module 210) at least partially within the housing, the wireless network module coupled to the one or more processors, and a human-machine interface (e.g., human machine interface 212). In some implementations, the wireless network module is configured to utilize any known wireless network protocol such as Bluetooth, WiFi, voice over Internet Protocol (VoIP), infrared, or any other suitable communication protocol.

The human-machine interface consists essentially of at least one speaker (e.g., speaker 216) at least partially within the housing, at least one microphone (e.g., microphone 218) at least partially within the housing, an analog to digital converter (e.g., ADC 410 in audio subsystem 214, as described below with reference to FIG. 4) coupled to the microphone and configured to convert speech into digital signals, a digital to analog converter (e.g., DAC 412 in audio subsystem 214, as described below with reference to FIG. 4) coupled to the at least one speaker and configured to convert received data into audio signals, including speech, and zero or more additional components, coupled to the one or more processors, selected from the set consisting of: a touch-sensitive surface (e.g., touch-sensitive surface 227) configured to receive touch inputs; one or more cameras (e.g., camera(s) 223); and one or more LEDs (e.g., LED(s) 225). In some implementations, the analog to digital converter corresponds to a codec. In some implementations, the digital to analog converter corresponds to a codec. In some implementations, the codec is configured to utilize a user-specific adaptive speech recognition model. For example, requiring user to enter a training mode to update the model, or receiving the adaptive model from the digital assistant server (e.g., digital assistant server 106). In some implementations, the touch-sensitive surface is integrated into a portion of the housing (e.g., the user makes contact with the portion of the housing to provide input to the voice activated device). In some implementations, the touch-sensitive surface replaces part of the housing. In some implementations, the touch-sensitive surface is used to toggle sleep mode on the voice activated device. In some implementations, the touch-sensitive surface is used as an alternative input option for a user input request (e.g., to answer a yes/no query). In some implementations, the one or more cameras are configured to ID the user. In some implementations, the one or more cameras are configured to take pictures and/or video when requested by the user. In some implementations, the one or more cameras are configured to detect the environment around the voice activated device. In some implementations, the LEDs are configured to provide user feedback. In some implementations, the LEDs are configured to indicate the voice activated device's current state.

In some embodiments, the voice activated device is configured to act as an interface for speech communications between the user and a digital assistant of the user on the digital assistant server.

In some embodiments, the voice activated device is coupled with one or more additional instances of the voice activated device via a wireless network and the voice activated device shares information with the one or more additional instances of the voice activated device. For example, voice activated devices in different rooms of a house are coupled together and function as a single voice activated device when interacting with a user (e.g., the voice activated devices collaborate on assisting the user).

In some embodiments, the voice activated device is further configured to provide intercom communication between the one or more coupled devices. For example, when prompted by a user, a voice activated device in a kitchen of a house acts as an intercom with a voice activated device in a bedroom of the house.

In some embodiments, the voice activated device also includes one or more light sensors coupled to the one or more processors. In some implementations, the light sensors are configured to assist the voice activated device in detecting nearby activity. In some implementations, the voice activated device is further configured to utilize the light sensors when determining the appropriate operating mode (e.g., when to enter sleep mode).

In some embodiments, the voice activated device also includes a motion sensor to detect motion in proximity to the voice activated device.

In some embodiments, the voice activated device also includes a fire detection module (e.g., a smoke detector) coupled to the one or more processors. In some embodiments, the voice activated device also includes a carbon monoxide detection module coupled to the one or more processors.

In some embodiments, the memory stores a personalized configuration (e.g., user specific settings files) for each of a plurality of users, and the voice activated device is further configured, when activated by a respective user, to provide services to the respective user utilizing the respective personalized configuration. In some implementations, activating the voice activated device includes logging into the voice activated device. In some implementations, activating the voice activated device includes identifying the respective user by using a voice recognition model corresponding to the respective user.

In some embodiments, the voice activated device is further configured to play audio files (e.g., music files) associated with the user. In some implementations, the audio files are stored in memory on the voice activated device. In some implementations, the audio files are stored in memory on a server (e.g., digital assistant server 106, a remote media server, or a network attached storage system), distinct from the voice activated device. In some implementations, the audio files are streamed from a remote server (e.g., a radio station).

In some embodiments, the voice activated device is further configured for home automation. For example, in some implementations, the voice activated device is configured to control room lights, house lights, room temperature, various electronics (e.g., a television) and various kitchen appliances (e.g., a coffee maker).

In some embodiments, the voice activated device is further configured to function as a timer when prompted by the user. For example, in some implementations, the voice activated device is used as a cooking timer and/or an exercise timer.

In some embodiments, the voice activated device is further configured to access (e.g., via the wireless network module) a news source (e.g., the associated press or user preferred news site) and provide news to the user when prompted by the user. For example, in some implementations, the voice activated device provides weather information, stock information, sports scores, and/or headlines.

In some embodiments, the voice activated device is further configured to store the converted user speech in memory when prompted by the user. For example, in some implementations, take notes while the user dictates information (e.g., a speech or a paper).

In some embodiments, the wireless network module is further configured to couple to one or more user devices. For example, user devices include cellular phones, tablet computers, laptop computers, desktop computers, televisions, cable boxes, and the like.

In some embodiments, the voice activated device is further configured to provide text-to-speech (TTS) communication between the user and a second party. For example, in some implementations, the voice activated device receives a text message via a wireless network, converts the text message to a corresponding audio signal, and outputs (e.g., via speaker 216 in FIG. 2) the audio signal to the user.

In some embodiments, the voice activated device is further configured to provide speech-to-text communication between the user and a second party. For example, in some implementations, the voice activated device receives user speech (e.g., via microphone 218 in FIG. 2), converts the speech to a text message, and sends the text message to a second device designated by the user (e.g., via wireless network module 210 in FIG. 2).

In some embodiments, the voice activated device is coupled to a telephone associated with the user and the voice activated device is further configured to provide telecommunication via the telephone for the user. For example, in some implementations, the voice activated device is configured to function similar to a wireless headset (e.g., receiving voice inputs via microphone 218 and providing audible outputs via speaker 216).

In some embodiments, the voice activated device is further configured to provide notifications received from the one or more coupled devices to the user. In some implementations, the voice activated device receives a low battery warning from a coupled device (e.g., a cellphone or a laptop computer). In some of these implementations, the voice activated device audibly provides the warning to the user. In some implementations, the voice activated device receives an event notification (e.g., a voice message, text message, and/or calendar event) from a coupled device. In some of these implementations, the voice activated device audibly provides the event notification to the user.

In some embodiments, the voice activated device is further configured to access the user's calendar. In some implementations, the user's calendar is stored in memory on the voice activated device. In some implementations, the user's calendar is stored on a device (e.g., digital assistant server 106, a remote media server, a network attached storage system, or a user's phone or personal computer) that is remote from the voice activated device and is accessed via the wireless network module. In some implementations, the user's calendar is stored on the digital assistant server.

In some embodiments, the voice activated device is further configured to provide calendar reminders to the user. In some implementations, the voice activated device provides reminders when prompted by the user. In some implementations, the voice activated device provides reminders at a preset time before (e.g., a reminder 30 minutes for a meeting) and/or after the event occurs.

In some embodiments, the voice activated device is further configured to update the user's calendar. In some implementations, the voice activated device adds a calendar event after making an appointment (e.g., a doctor's appointment, a restaurant reservation, and the like) for the user. In some implementations, the voice activated device adds a calendar event when prompted by the user.

In some embodiments, the voice activated device is further configured to access a set of instructions and output the instruction steps when prompted by the user. For example, the voice activated device accesses a cooking recipe and recites the recipe steps as requested by the user. In some implementations, the voice activated device accesses the instructions from memory in the voice activated device. In some implementations, the voice activated device accesses the instructions from a coupled device (e.g., a user's phone, personal computer or network attached storage). In some implementations, the voice activated device accesses the instructions from the digital assistant server. In some implementations the voice activated device outputs all of the instruction steps when prompted. In some implementations the voice activated device outputs one instruction step when prompted and outputs each instruction step in sequence over successive prompts.

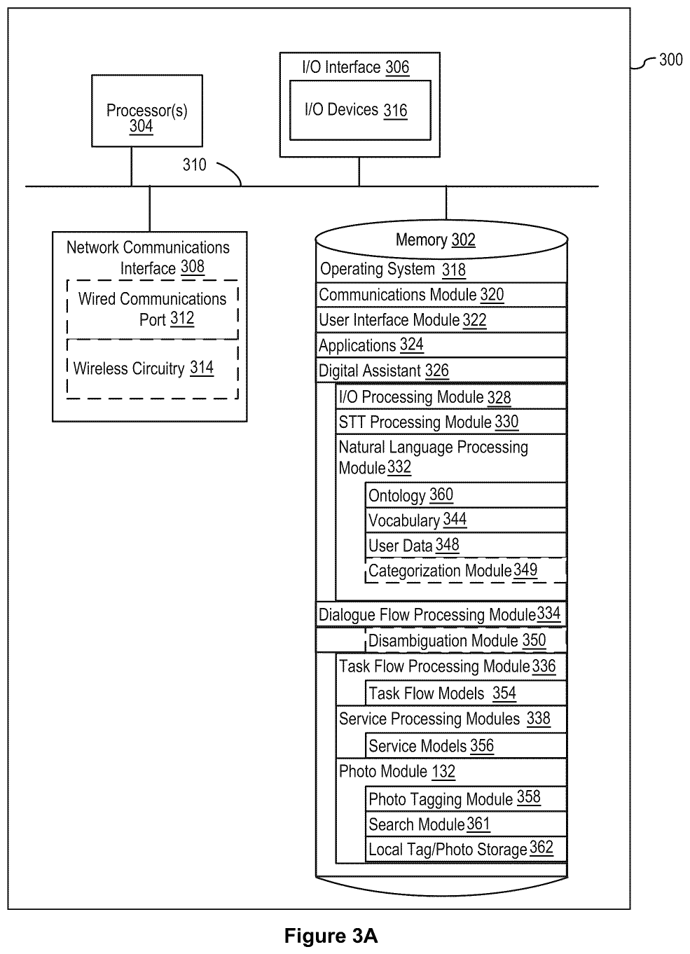

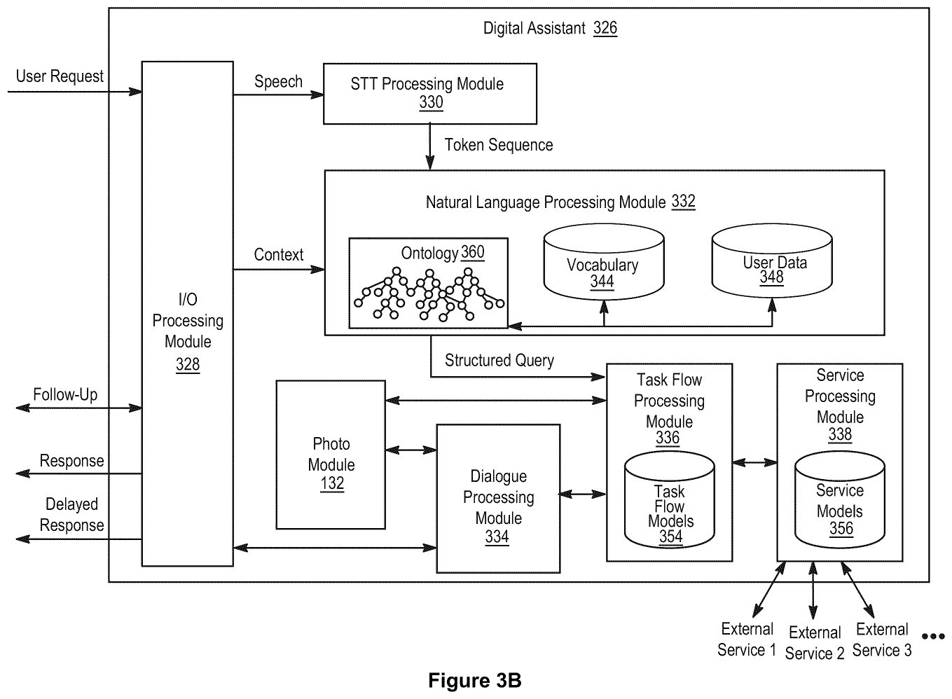

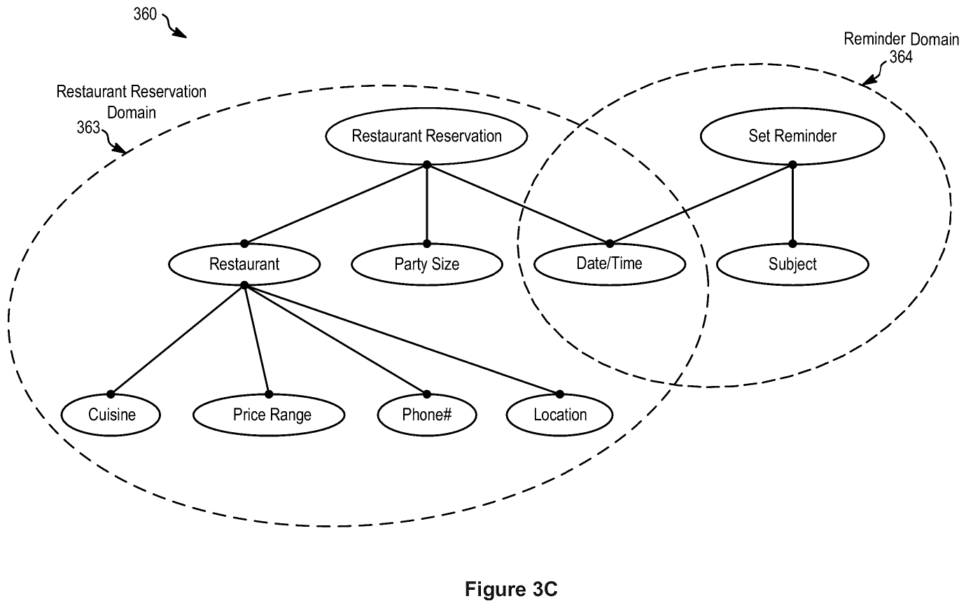

In some embodiments, the voice activated device is further configured to store in memory one or more macros provided by the user, where each macro is associated with a respective phrase (e.g., a trigger word or “Magic Word”). In some of these embodiments, the voice activated device is further configured to play the macro associated with the respective phrase when the respective phrase is spoken by the user. In some implementations, the memory is memory within the voice activated device (e.g., memory 206 in FIG. 2). In some implementations, the memory is memory on the digital assistant server (e.g., memory 302 in FIG. 3A). For example, the phrase “Good Morning Assistant” is, optionally, associated with a macro for the user's morning routine (e.g., provides news, turns on coffee maker, and checks weather). In some implementations, the phrase “Goodbye now Assistant” is, optionally, associated with a macro for turning off the house lights and entering security mode.

FIG. 3A is a block diagram of an exemplary digital assistant system 300 (also referred to as the digital assistant) in accordance with some implementations. In some implementations, the digital assistant system 300 is implemented on a standalone computer system. In some implementations, the digital assistant system 300 is distributed across multiple computers. In some implementations, some of the modules and functions of the digital assistant are divided into a server portion and a client portion, where the client portion resides on a user device (e.g., voice activated device 102) and communicates with the server portion (e.g., the server system 108) through one or more networks, e.g., as shown in FIG. 1. In some implementations, the digital assistant system 300 is an embodiment of the server system 108 (and/or the digital assistant server 106) shown in FIG. 1. In some implementations, the digital assistant system 300 is implemented in a user device (e.g., the voice activated device 102, FIG. 1), thereby eliminating the need for a client-server system. It should be noted that the digital assistant system 300 is only one example of a digital assistant system, and that the digital assistant system 300 may have more or fewer components than shown, may combine two or more components, or may have a different configuration or arrangement of the components. The various components shown in FIG. 3A may be implemented in hardware, software, firmware, including one or more signal processing and/or application specific integrated circuits, or a combination of thereof.

The digital assistant system 300 includes memory 302, one or more processors 304, an input/output (I/O) interface 306, and a network communications interface 308. These components communicate with one another over one or more communication buses or signal lines 310.

In some implementations, memory 302 includes a non-transitory computer readable medium, such as high-speed random access memory and/or a non-volatile computer readable storage medium (e.g., one or more magnetic disk storage devices, one or more flash memory devices, one or more optical storage devices, and/or other non-volatile solid-state memory devices).

The I/O interface 306 couples input/output devices 316 of the digital assistant system 300, such as displays, a keyboards, touch screens, and microphones, to the user interface module 322. The I/O interface 306, in conjunction with the user interface module 322, receives user inputs (e.g., voice input, keyboard inputs, touch inputs, etc.) and process them accordingly. In some implementations, when the digital assistant is implemented on a standalone user device, the digital assistant system 300 includes any of the components and I/O and communication interfaces described with respect to the voice activated device 102 in FIG. 2 (e.g., one or more microphones 216). In some implementations, the digital assistant system 300 represents the server portion of a digital assistant implementation, and interacts with the user through a client-side portion residing on a user device (e.g., the voice activated device 102 shown in FIG. 2).

In some implementations, the network communications interface 308 eludes wired communication port(s) 312 and/or wireless transmission and reception circuitry 314. The wired communication port(s) receive and send communication signals via one or more wired interfaces, e.g., Ethernet, Universal Serial Bus (USB), FIREWIRE, etc. The wireless circuitry 314 typically receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 308 enables communication between the digital assistant system 300 with networks, such as the Internet, an intranet and/or a wireless network, such as a cellular telephone network, a wireless local area network (LAN) and/or a metropolitan area network (MAN), and other devices.

In some implementations, the non-transitory computer readable storage medium of memory 302 stores programs, modules, instructions, and data structures including all or a subset of: an operating system 318, a communications module 320, a user interface module 322, one or more applications 324, and a digital assistant module 326. The one or more processors 304 execute these programs, modules, and instructions, and reads/writes from/to the data structures.

The operating system 318 (e.g., Darwin, RTXC, LINUX, UNIX, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

The communications module 320 facilitates communications between the digital assistant system 300 with other devices over the network communications interface 308. For example, the communication module 320 may communicate with the communications module of the voice activated device 102 shown in FIG. 2. The communications module 320 also includes various software components for handling data received by the wireless circuitry 314 and/or wired communications port 312.

In some implementations, the user interface module 322 receives commands and/or inputs from a user via the I/O interface 306 (e.g., from a keyboard, touch screen, and/or microphone), and provides user interface objects on a display.

The applications 324 include programs and/or modules that are configured to be executed by the one or more processors 304. For example, if the digital assistant system is implemented on a standalone user device, the applications 324 may include user applications, such as games, a calendar application, a navigation application, or an email application. If the digital assistant system 300 is implemented on a server farm, the applications 324 may include resource management applications, diagnostic applications, or scheduling applications, for example.

Memory 302 also stores the digital assistant module (or the server portion of a digital assistant) 326. In some implementations, the digital assistant module 326 includes the following sub-modules, or a subset or superset thereof: an input/output processing module 328, a speech-to-text (STT) processing module 330, a natural language processing module 332, a dialogue flow processing module 334, a task flow processing module 336, a service processing module 338, and a photo module 132. Each of these processing modules has access to one or more of the following data and models of the digital assistant 326, or a subset or superset thereof: ontology 360, vocabulary index 344, user data 348, categorization module 349, disambiguation module 350, task flow models 354, service models 356, photo tagging module 358, search module 360, and local tag/photo storage 362.

In some implementations, using the processing modules (e.g., the input/output processing module 328, the STT processing module 330, the natural language processing module 332, the dialogue flow processing module 334, the task flow processing module 336, and/or the service processing module 338), data, and models implemented in the digital assistant module 326, the digital assistant system 300 performs at least some of the following: identifying a user's intent expressed in a natural language input received from the user; actively eliciting and obtaining information needed to fully deduce the user's intent (e.g., by disambiguating words, names, intentions, etc.); determining the task flow for fulfilling the deduced intent; and executing the task flow to fulfill the deduced intent. In some implementations, the digital assistant also takes appropriate actions when a satisfactory response was not or could not be provided to the user for various reasons.

In some implementations, as discussed below, the digital assistant system 300 identifies, from a natural language input, a user's intent to tag a digital photograph, and processes the natural language input so as to tag the digital photograph with appropriate information. In some implementations, the digital assistant system 300 performs other tasks related to photographs as well, such as searching for digital photographs using natural language input, auto-tagging photographs, and the like.

As shown in FIG. 3B, in some implementations, the I/O processing module 328 interacts with the user through the I/O devices 316 in FIG. 3A or with a user device (e.g., a user device 104 in FIG. 1) through the network communications interface 308 in FIG. 3A to obtain user input (e.g., a speech input) and to provide responses to the user input. The I/O processing module 328 optionally obtains context information associated with the user input from the user device, along with or shortly after the receipt of the user input. The context information includes user-specific data, vocabulary, and/or preferences relevant to the user input. In some implementations, the context information also includes software and hardware states of the voice activated device (e.g., voice activated device 102 in FIG. 1) at the time the user request is received, and/or information related to the surrounding environment of the user at the time that the user request was received. In some implementations, the I/O processing module 328 also sends follow-up questions to, and receives answers from, the user regarding the user request. In some implementations, when a user request is received by the I/O processing module 328 and the user request contains a speech input, the I/O processing module 328 forwards the speech input to the speech-to-text (STT) processing module 330 for speech-to-text conversions.

In some implementations, the speech-to-text processing module 330 receives speech input (e.g., a user utterance captured in a voice recording) through the I/O processing module 328. In some implementations, the speech-to-text processing module 330 uses various acoustic and language models to recognize the speech input as a sequence of phonemes, and ultimately, a sequence of words or tokens written in one or more languages. The speech-to-text processing module 330 is implemented using any suitable speech recognition techniques, acoustic models, and language models, such as Hidden Markov Models, Dynamic Time Warping (DTW)-based speech recognition, and other statistical and/or analytical techniques. In some implementations, the speech-to-text processing can be performed at least partially by a third party service or on the user's device. Once the speech-to-text processing module 330 obtains the result of the speech-to-text processing (e.g., a sequence of words or tokens), it passes the result to the natural language processing module 332 for intent deduction.

The natural language processing module 332 (“natural language processor”) of the digital assistant 326 takes the sequence of words or tokens (“token sequence”) generated by the speech-to-text processing module 330, and attempts to associate the token sequence with one or more “actionable intents” recognized by the digital assistant. As used herein, an “actionable intent” represents a task that can be performed by the digital assistant 326 and/or the digital assistant system 300 (FIG. 3A), and has an associated task flow implemented in the task flow models 354. The associated task flow is a series of programmed actions and steps that the digital assistant system 300 takes in order to perform the task. The scope of a digital assistant system's capabilities is dependent on the number and variety of task flows that have been implemented and stored in the task flow models 354, or in other words, on the number and variety of “actionable intents” that the digital assistant system 300 recognizes. The effectiveness of the digital assistant system 300, however, is also dependent on the digital assistant system's ability to deduce the correct “actionable intent(s)” from the user request expressed in natural language.

In some implementations, in addition to the sequence of words or tokens obtained from the speech-to-text processing module 330, the natural language processor 332 also receives context information associated with the user request (e.g., from the I/O processing module 328). The natural language processor 332 optionally uses the context information to clarify, supplement, and/or further define the information contained in the token sequence received from the speech-to-text processing module 330. The context information includes, for example, user preferences, hardware and/or software states of the user device (e.g., voice activated device 102), sensor information collected before, during, or shortly after the user request, prior interactions (e.g., dialogue) between the digital assistant and the user, and the like.

In some implementations, the natural language processing is based on an ontology 360. The ontology 360 is a hierarchical structure containing a plurality of nodes, each node representing either an “actionable intent” or a “property” relevant to one or more of the “actionable intents” or other “properties.” As noted above, an “actionable intent” represents a task that the digital assistant system 300 is capable of performing (e.g., a task that is “actionable” or can be acted on). A “property” represents a parameter associated with an actionable intent or a sub-aspect of another property. A linkage between an actionable intent node and a property node in the ontology 360 defines how a parameter represented by the property node pertains to the task represented by the actionable intent node.

In some implementations, the ontology 360 is made up of actionable intent nodes and property nodes. Within the ontology 360, each actionable intent node is linked to one or more property nodes either directly or through one or more intermediate property nodes. Similarly, each property node is linked to one or more actionable intent nodes either directly or through one or more intermediate property nodes. For example, the ontology 360 shown in FIG. 3C includes a “restaurant reservation” node, which is an actionable intent node. Property nodes “restaurant,” “date/time” (for the reservation), and “party size” are each directly linked to the “restaurant reservation” node (i.e., the actionable intent node). In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, the ontology 360 shown in FIG. 3C also includes a “set reminder” node, which is another actionable intent node. Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in the ontology 360.

An actionable intent node, along with its linked concept nodes, may be described as a “domain.” In the present discussion, each domain is associated with a respective actionable intent, and refers to the group of nodes (and the relationships therebetween) associated with the particular actionable intent. For example, the ontology 360 shown in FIG. 3C includes an example of a restaurant reservation domain 362 and an example of a reminder domain 364 within the ontology 360. The restaurant reservation domain includes the actionable intent node “restaurant reservation,” property nodes “restaurant,” “date/time,” and “party size,” and sub-property nodes “cuisine,” “price range,” “phone number,” and “location.” The reminder domain 364 includes the actionable intent node “set reminder,” and property nodes “subject” and “date/time.” In some implementations, the ontology 360 is made up of many domains. Each domain may share one or more property nodes with one or more other domains. For example, the “date/time” property node may be associated with many other domains (e.g., a scheduling domain, a travel reservation domain, a movie ticket domain, etc.), in addition to the restaurant reservation domain 362 and the reminder domain 364.

While FIG. 3C illustrates two exemplary domains within the ontology 360, the ontology 360 may include other domains (or actionable intents), such as “initiate a phone call,” “find directions,” “schedule a meeting,” “send a message,” and “provide an answer to a question,” “tag a photo,” and so on. For example, a “send a message” domain is associated with a “send a message” actionable intent node, and may further include property nodes such as “recipient(s),” “message type,” and “message body.” The property node “recipient” may be further defined, for example, by the sub-property nodes such as “recipient name” and “message address.”

In some implementations, the ontology 360 includes all the domains (and hence actionable intents) that the digital assistant is capable of understanding and acting upon. In some implementations, the ontology 360 may be modified, such as by adding or removing domains or nodes, or by modifying relationships between the nodes within the ontology 360.

In some implementations, nodes associated with multiple related actionable intents may be clustered under a “super domain” in the ontology 360. For example, a “travel” super-domain may include a cluster of property nodes and actionable intent nodes related to travels. The actionable intent nodes related to travels may include “airline reservation,” “hotel reservation,” “car rental,” “get directions,” “find points of interest,” and so on. The actionable intent nodes under the same super domain (e.g., the “travels” super domain) may have many property nodes in common. For example, the actionable intent nodes for “airline reservation,” “hotel reservation,” “car rental,” “get directions,” “find points of interest” may share one or more of the property nodes “start location,” “destination,” “departure date/time,” “arrival date/time,” and “party size.”

In some implementations, each node in the ontology 360 is associated with a set of words and/or phrases that are relevant to the property or actionable intent represented by the node. The respective set of words and/or phrases associated with each node is the so-called “vocabulary” associated with the node. The respective set of words and/or phrases associated with each node can be stored in the vocabulary index 344 (FIG. 3B) in association with the property or actionable intent represented by the node. For example, returning to FIG. 3B, the vocabulary associated with the node for the property of “restaurant” may include words such as “food,” “drinks,” “cuisine,” “hungry,” “eat,” “pizza,” “fast food,” “meal,” and so on. For another example, the vocabulary associated with the node for the actionable intent of “initiate a phone call” may include words and phrases such as “call,” “phone,” “dial,” “ring,” “call this number,” “make a call to,” and so on. The vocabulary index 344 optionally includes words and phrases in different languages.

In some implementations, the natural language processor 332 shown in FIG. 3B receives the token sequence (e.g., a text string) from the speech-to-text processing module 330, and determines what nodes are implicated by the words in the token sequence. In some implementations, if a word or phrase in the token sequence is found to be associated with one or more nodes in the ontology 360 (via the vocabulary index 344), the word or phrase will “trigger” or “activate” those nodes. When multiple nodes are “triggered,” based on the quantity and/or relative importance of the activated nodes, the natural language processor 332 will select one of the actionable intents as the task (or task type) that the user intended the digital assistant to perform. In some implementations, the domain that has the most “triggered” nodes is selected. In some implementations, the domain having the highest confidence value (e.g., based on the relative importance of its various triggered nodes) is selected. In some implementations, the domain is selected based on a combination of the number and the importance of the triggered nodes. In some implementations, additional factors are considered in selecting the node as well, such as whether the digital assistant system 300 has previously correctly interpreted a similar request from a user.

In some implementations, the digital assistant system 300 also stores names of specific entities in the vocabulary index 344, so that when one of these names is detected in the user request, the natural language processor 332 will be able to recognize that the name refers to a specific instance of a property or sub-property in the ontology. In some implementations, the names of specific entities are names of businesses, restaurants, people, movies, and the like. In some implementations, the digital assistant system 300 can search and identify specific entity names from other data sources, such as the user's address book or contact list, a movies database, a musicians database, and/or a restaurant database. In some implementations, when the natural language processor 332 identifies that a word in the token sequence is a name of a specific entity (such as a name in the user's address book or contact list), that word is given additional significance in selecting the actionable intent within the ontology for the user request.

For example, when the words “Mr. Santo” are recognized from the user request, and the last name “Santo” is found in the vocabulary index 344 as one of the contacts in the user's contact list, then it is likely that the user request corresponds to a “send a message” or “initiate a phone call” domain. For another example, when the words “ABC Café” are found in the user request, and the term “ABC Café” is found in the vocabulary index 344 as the name of a particular restaurant in the user's city, then it is likely that the user request corresponds to a “restaurant reservation” domain.

User data 348 includes user-specific information, such as user-specific vocabulary, user preferences, user address, user's default and secondary languages, user's contact list, and other short-term in or long-term information for each user. The natural language processor 332 can use the user-specific information to supplement the information contained in the user input to further define the user intent. For example, for a user request “invite my friends to my birthday party,” the natural language processor 332 is able to access user data 348 to determine who the “friends” are and when and where the “birthday party” would be held, rather than requiring the user to provide such information explicitly in his/her request.

In some implementations, natural language processor 332 includes categorization module 349. In some implementations, the categorization module 349 determines whether each of the one or more terms in a text string (e.g., corresponding to a speech input associated with a digital photograph) is one of an entity, an activity, or a location, as discussed in greater detail below. In some implementations, the categorization module 349 classifies each term of the one or more terms as one of an entity, an activity, or a location.

Once the natural language processor 332 identifies an actionable intent (or domain) based on the user request, the natural language processor 332 generates a structured query to represent the identified actionable intent. In some implementations, the structured query includes parameters for one or more nodes within the domain for the actionable intent, and at least some of the parameters are populated with the specific information and requirements specified in the user request. For example, the user may say “Make me a dinner reservation at a sushi place at 7.” In this case, the natural language processor 332 may be able to correctly identify the actionable intent to be “restaurant reservation” based on the user input. According to the ontology, a structured query for a “restaurant reservation” domain may include parameters such as {Cuisine}, {Time}, {Date}, {Party Size}, and the like. Based on the information contained in the user's utterance, the natural language processor 332 may generate a partial structured query for the restaurant reservation domain, where the partial structured query includes the parameters {Cuisine=“Sushi” } and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some implementations, the natural language processor 332 populates some parameters of the structured query with received context information. For example, if the user requested a sushi restaurant “near me,” the natural language processor 332 may populate a {location} parameter in the structured query with GPS coordinates from the user device 104.

In some implementations, the natural language processor 332 passes the structured query (including any completed parameters) to the task flow processing module 336 (“task flow processor”). The task flow processor 336 is configured to perform one or more of: receiving the structured query from the natural language processor 332, completing the structured query, and performing the actions required to “complete” the user's ultimate request. In some implementations, the various procedures necessary to complete these tasks are provided in task flow models 354. In some implementations, the task flow models 354 include procedures for obtaining additional information from the user, and task flows for performing actions associated with the actionable intent.

As described above, in order to complete a structured query, the task flow processor 336 may need to initiate additional dialogue with the user in order to obtain additional information, and/or disambiguate potentially ambiguous utterances. When such interactions are necessary, the task flow processor 336 invokes the dialogue processing module 334 (“dialogue processor”) to engage in a dialogue with the user. In some implementations, the dialogue processing module 334 determines how (and/or when) to ask the user for the additional information, and receives and processes the user responses. In some implementations, the questions are provided to and answers are received from the users through the I/O processing module 328. For example, the dialogue processing module 334 presents dialogue output to the user via audio and/or visual output, and receives input from the user via spoken or physical (e.g., touch gesture) responses. Continuing with the example above, when the task flow processor 336 invokes the dialogue processor 334 to determine the “party size” and “date” information for the structured query associated with the domain “restaurant reservation,” the dialogue processor 334 generates questions such as “For how many people?” and “On which day?” to pass to the user. Once answers are received from the user, the dialogue processing module 334 populates the structured query with the missing information, or passes the information to the task flow processor 336 to complete the missing information from the structured query.

In some cases, the task flow processor 336 may receive a structured query that has one or more ambiguous properties. For example, a structured query for the “send a message” domain may indicate that the intended recipient is “Bob,” and the user may have multiple contacts named “Bob.” The task flow processor 336 will request that the dialogue processor 334 disambiguate this property of the structured query. In turn, the dialogue processor 334 may ask the user “Which Bob?”, and display (or read) a list of contacts named “Bob” from which the user may choose.

In some implementations, dialogue processor 334 includes disambiguation module 350. In some implementations, disambiguation module 350 disambiguates one or more ambiguous terms (e.g., one or more ambiguous terms in a text string corresponding to a speech input associated with a digital photograph). In some implementations, disambiguation module 350 identifies that a first term of the one or more terms has multiple candidate meanings, prompts a user for additional information about the first term, receives the additional information from the user in response to the prompt and identifies the entity, activity, or location associated with the first term in accordance with the additional information.

In some implementations, disambiguation module 350 disambiguates pronouns. In such implementations, disambiguation module 350 identifies one of the one or more terms as a pronoun and determines a noun to which the pronoun refers. In some implementations, disambiguation module 350 determines a noun to which the pronoun refers by using a contact list associated with a user of the voice activated device. Alternatively, or in addition, disambiguation module 350 determines a noun to which the pronoun refers as a name of an entity, an activity, or a location identified in a previous speech input associated with a previously tagged digital photograph. Alternatively, or in addition, disambiguation module 350 determines a noun to which the pronoun refers as a name of a person identified based on a previous speech input associated with a previously tagged digital photograph.

In some implementations, disambiguation module 350 accesses information obtained from one or more sensors (e.g., motion sensor 230, light sensor 234, fire sensor 236, and other sensors 232) of a user device (e.g., voice activated device 102) for determining a meaning of one or more of the terms. In some implementations, disambiguation module 350 identifies two terms each associated with one of an entity, an activity, or a location. For example, a first of the two terms refers to a person, and a second of the two terns refers to a location. In some implementations, disambiguation module 350 identifies three terms each associated with one of an entity, an activity, or a location.

Once the task flow processor 336 has completed the structured query for an actionable intent, the task flow processor 336 proceeds to perform the ultimate task associated with the actionable intent. Accordingly, the task flow processor 336 executes the steps and instructions in the task flow model according to the specific parameters contained in the structured query. For example, the task flow model for the actionable intent of “restaurant reservation” may include steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, the task flow processor 336 may perform the steps of: (1) logging onto a server of the ABC Café or a restaurant reservation system that is configured to accept reservations for multiple restaurants, such as the ABC Café, (2) entering the date, time, and party size information in a form on the website, (3) submitting the form, and (4) making a calendar entry for the reservation in the user's calendar. In another example, described in greater detail below, the task flow processor 336 executes steps and instructions associated with tagging or searching for digital photographs in response to a voice input, e.g., in conjunction with photo module 132.

In some implementations, the task flow processor 336 employs the assistance of a service processing module 338 (“service processor”) to complete a task requested in the user input or to provide an informational answer requested in the user input. For example, the service processor 338 can act on behalf of the task flow processor 336 to make a phone call, set a calendar entry, invoke a map search, invoke or interact with other user applications installed on the user device (e.g., voice activated device 102), and invoke or interact with third party services (e.g. a restaurant reservation portal, a social networking website or service, a banking portal, etc.). In some implementations, the protocols and application programming interfaces (API) required by each service can be specified by a respective service model among the service models 356. The service processor 338 accesses the appropriate service model for a service and generates requests for the service in accordance with the protocols and APIs required by the service according to the service model.

For example, if a restaurant has enabled an online reservation service, the restaurant can submit a service model specifying the necessary parameters for making a reservation and the APIs for communicating the values of the necessary parameters to the online reservation service. When requested by the task flow processor 336, the service processor 338 can establish a network connection with the online reservation service using the web address stored in the service models 356, and send the necessary parameters of the reservation (e.g., time, date, party size) to the online reservation interface in a format according to the API of the online reservation service.

In some implementations, the natural language processor 332, dialogue processor 334, and task flow processor 336 are used collectively and iteratively to deduce and define the user's intent, obtain information to further clarify and refine the user intent, and finally generate a response (e.g., provide an output to the user, or complete a task) to fulfill the user's intent.

In some implementations, after all of the tasks needed to fulfill the user's request have been performed, the digital assistant 326 formulates a confirmation response, and sends the response back to the user through the I/O processing module 328. If the user request seeks an informational answer, the confirmation response presents the requested information to the user. In some implementations, the digital assistant also requests the user to indicate whether the user is satisfied with the response produced by the digital assistant 326.

Attention is now directed to FIG. 4, which is a block diagram illustrating components of an audio subsystem 214, in accordance with some implementations. (The audio subsystem 214 is not limited to voice, and implementations described herein apply equally to non-voice sounds.) The audio subsystem 214 is composed of various components, modules, and/or software programs within voice activated device 102.

In some implementations, audio subsystem 214 includes analog to digital converter (ADC) 410, digital to analog converter (DAC) 412, and voice trigger system 220. In some implementations, the audio subsystem 226 is coupled to one or more microphones 218 (FIG. 2) and one or more speakers 216 (FIG. 2). The audio subsystem 214 provides sound inputs to the detectors (e.g., noise detector 402, sound-type detector 404, and trigger sound detector 406) and the speech-based service 408 (as well as other components or modules, such as wireless network module 210) for processing and/or analysis.

In some implementations, voice trigger system 220 includes a noise detector 402, a sound-type detector 404, a trigger sound detector 406, and a speech-based service 408, each coupled to an audio bus 401. In some implementations, more or fewer of these modules are used. The detectors (e.g., noise detector 402, sound-type detector 404, and trigger sound detector 406) are, optionally, referred to as modules, and optionally include hardware (e.g., circuitry, memory, processors, etc.), software (e.g., programs, software-on-a-chip, firmware, etc.), and/or any combinations thereof for performing the functionality described herein. In some implementations, the sound detectors are communicatively, programmatically, physically, and/or operationally coupled to one another (e.g., via a communications bus), as illustrated in FIG. 4 by the broken lines. For ease of illustration, FIG. 4 shows each sound detector coupled only to adjacent sound detectors. It will be understood that the each sound detector is, optionally, coupled to any of the other sound detectors as well.

In some implementations, the speech-based service 408 is a voice-based digital assistant, and corresponds to one or more components or functionalities of the digital assistant system described above with reference to FIGS. 1, 2, and 3A-3C. In some implementations, the speech-based service is a speech-to-text service, a dictation service, or the like.

In some implementations, the noise detector 402 monitors an audio channel to determine whether a sound input satisfies a predetermined condition, such as an amplitude threshold. The audio channel corresponds to a stream of audio information received by one or more sound pickup devices, such as the one or more microphones 218 (FIG. 2). The audio channel refers to the audio information regardless of its state of processing or the particular hardware that is processing and/or transmitting the audio information. For example, the audio channel may refer to analog electrical impulses (and/or the circuits on which they are propagated) from the microphone 218, as well as a digitally encoded audio stream resulting from processing of the analog electrical impulses (e.g., by ADC 410 and/or any other audio processing system of the voice activated device 102).

In some implementations, the predetermined condition is whether the sound input is above a certain volume for a predetermined amount of time. In some implementations, the noise detector uses time-domain analysis of the sound input, which requires relatively little computational and battery resources as compared to other types of analysis (e.g., as performed by the sound-type detector 404, the trigger word detector 406, and/or the speech-based service 408). In some implementations, other types of signal processing and/or audio analysis are used, including, for example, frequency-domain analysis. If the noise detector 402 determines that the sound input satisfies the predetermined condition, it initiates an upstream sound detector, such as the sound-type detector 404 (e.g., by providing a control signal to initiate one or more processing routines, and/or by providing power to the upstream sound detector). In some implementations, the upstream sound detector is initiated in response to other conditions being satisfied. For example, in some implementations, the upstream sound detector is initiated in response to determining that the voice activated device is not being stored in an enclosed space (e.g., based on a light detector detecting a threshold level of light).

The sound-type detector 404 monitors the audio channel to determine whether a sound input corresponds to a certain type of sound, such as sound that is characteristic of a human voice, whistle, clap, etc. The type of sound that the sound-type detector 404 is configured to recognize will correspond to the particular trigger sound(s) that the voice trigger is configured to recognize. In implementations where the trigger sound is a spoken word or phrase, the sound-type detector 404 includes a “voice activity detector” (VAD). In some implementations, the sound-type detector 404 uses frequency-domain analysis of the sound input. For example, the sound-type detector 404 generates a spectrogram of a received sound input (e.g., using a Fourier transform), and analyzes the spectral components of the sound input to determine whether the sound input is likely to correspond to a particular type or category of sounds (e.g., human speech). Thus, in implementations where the trigger sound is a spoken word or phrase, if the audio channel is picking up ambient sound (e.g., traffic noise) but not human speech, the voice activity detector will not initiate the trigger sound detector 406.

In some implementations, the sound-type detector 404 remains active for as long as predetermined conditions of any downstream sound detector (e.g., the noise detector 402) are satisfied. For example, in some implementations, the sound-type detector 404 remains active as long as the sound input includes sound above a predetermined amplitude threshold (as determined by the noise detector 402), and is deactivated when the sound drops below the predetermined threshold. In some implementations, once initiated, the sound-type detector 404 remains active until a condition is met, such as the expiration of a timer (e.g., for 1, 2, 5, or 10 seconds, or any other appropriate duration), the expiration of a certain number of on/off cycles of the sound-type detector 404, or the occurrence of an event (e.g., the amplitude of the sound falls below a second threshold, as determined by the noise detector 402 and/or the sound-type detector 404).

As mentioned above, if the sound-type detector 404 determines that the sound input corresponds to a predetermined type of sound, it initiates an upstream sound detector (e.g., by providing a control signal to initiate one or more processing routines, and/or by providing power to the upstream sound detector), such as the trigger sound detector 406.

The trigger sound detector 406 is configured to determine whether a sound input includes at least part of certain predetermined content (e.g., at least part of the trigger word, phrase, or sound). In some implementations, the trigger sound detector 406 compares a representation of the sound input (an “input representation”) to one or more reference representations of the trigger word. If the input representation matches at least one of the one or more reference representations with an acceptable confidence, the trigger sound detector 406 initiates the speech-based service 408 (e.g., by providing a control signal to initiate one or more processing routines, and/or by providing power to the upstream sound detector). In some implementations, the input representation and the one or more reference representations are spectrograms (or mathematical representations thereof), which represent how the spectral density of a signal varies with time. In some implementations, the representations are other types of audio signatures or voiceprints. In some implementations, initiating the speech-based service 408 includes bringing one or more circuits, programs, and/or processors out of a standby mode, and invoking the sound-based service. The sound-based service is then ready to provide more comprehensive speech recognition, speech-to-text processing, and/or natural language processing.

In some implementations, the voice-trigger system 220 includes voice authentication functionality, so that it can determine if a sound input corresponds to a voice of a particular person, such as an owner/user of voice activated device 102. For example, in some implementations, the sound-type detector 404 uses a voiceprinting technique to determine that the sound input was uttered by an authorized user. Voice authentication and voiceprinting are described in more detail in U.S. patent application Ser. No. 13/053,144, which is hereby incorporated by reference in its entirety. In some implementations, voice authentication is included in any of the sound detectors described herein (e.g., the noise detector 402, the sound-type detector 404, the trigger sound detector 406, and/or the speech-based service 408). In some implementations, voice authentication is implemented as a separate module from the sound detectors listed above (e.g., as voice authentication module 428, FIG. 4), and may be operationally positioned after the noise detector 402, after the sound-type detector 404, after the trigger sound detector 406, or at any other appropriate position.

In some implementations, the trigger sound detector 406 remains active for as long as conditions of any downstream sound detector(s) (e.g., the noise detector 402 and/or the sound-type detector 404) are satisfied. For example, in some implementations, the trigger sound detector 406 remains active as long as the sound input includes sound above a predetermined threshold (as detected by the noise detector 402). In some implementations, it remains active as long as the sound input includes sound of a certain type (as detected by the sound-type detector 404). In some implementations, it remains active as long as both the foregoing conditions are met.

In some implementations, once initiated, the trigger sound detector 406 remains active until a condition is met, such as the expiration of a timer (e.g., for 1, 2, 5, or 10 seconds, or any other appropriate duration), the expiration of a certain number of on/off cycles of the trigger sound detector 406, or the occurrence of an event (e.g., the amplitude of the sound falls below a second threshold).

In some implementations, when one sound detector initiates another detector, both sound detectors remain active. However, the sound detectors may be active or inactive at various times, and it is not necessary that all of the downstream (e.g., the lower power and/or sophistication) sound detectors be active (or that their respective conditions are met) in order for upstream sound detectors to be active. For example, in some implementations, after the noise detector 402 and the sound-type detector 404 determine that their respective conditions are met, and the trigger sound detector 406 is initiated, one or both of the noise detector 402 and the sound-type detector 404 are deactivated and/or enter a standby mode while the trigger sound detector 406 operates. In other implementations, both the noise detector 402 and the sound-type detector 404 (or one or the other) stay active while the trigger sound detector 406 operates. In various implementations, different combinations of the sound detectors are active at different times, and whether one is active or inactive may depend on the state of other sound detectors, or may be independent of the state of other sound detectors.

While FIG. 4 describes three separate sound detectors, each configured to detect different aspects of a sound input, more or fewer sound detectors are used in various implementations of the voice trigger. For example, in some implementations, only the trigger sound detector 406 is used. In some implementations, the trigger sound detector 406 is used in conjunction with either the noise detector 402 or the sound-type detector 404. In some implementations, all of the detectors 402-406 are used. In some implementations, additional sound detectors are included as well.

Moreover, different combinations of sound detectors may be used at different times. For example, the particular combination of sound detectors and how they interact may depend on one or more conditions, such as the context or operating state of a voice activated device. As a specific example, if a voice activated device is plugged in (and thus not relying exclusively on battery power), the trigger sound detector 406 is active, while the noise detector 402 and the sound-type detector 404 remain inactive. In another example, if the voice activated device is in a pocket or backpack, all sound detectors are inactive.

By cascading sound detectors as described above, where the detectors that require more power are invoked only when necessary by detectors that require lower power, power efficient voice triggering functionality can be provided. As described above, additional power efficiency is achieved by operating one or more of the sound detectors according to a duty cycle. For example, in some implementations, the noise detector 402 operates according to a duty cycle so that it performs effectively continuous noise detection, even though the noise detector is off for at least part of the time. In some implementations, the noise detector 402 is on for 10 milliseconds and off for 90 milliseconds. In some implementations, the noise detector 402 is on for 20 milliseconds and off for 500 milliseconds. Other on and off durations are also possible.

In some implementations, if the noise detector 402 detects a noise during its “on” interval, the noise detector 402 will remain on in order to further process and/or analyze the sound input. For example, the noise detector 402 may be configured to initiate an upstream sound detector if it detects sound above a predetermined amplitude for a predetermined amount of time (e.g., 100 milliseconds). Thus, if the noise detector 402 detects sound above a predetermined amplitude during its 10 millisecond “on” interval, it will not immediately enter the “off” interval. Instead, the noise detector 402 remains active and continues to process the sound input to determine whether it exceeds the threshold for the full predetermined duration (e.g., 100 milliseconds).

In some implementations, the sound-type detector 404 operates according to a duty cycle. In some implementations, the sound-type detector 404 is on for 20 milliseconds and off for 100 milliseconds. Other on and off durations are also possible. In some implementations, the sound-type detector 404 is able to determine whether a sound input corresponds to a predetermined type of sound within the “on” interval of its duty cycle. Thus, the sound-type detector 404 will initiate the trigger sound detector 406 (or any other upstream sound detector) if the sound-type detector 404 determines, during its “on” interval, that the sound is of a certain type. Alternatively, in some implementations, if the sound-type detector 404 detects, during the “on” interval, sound that may correspond to the predetermined type, the detector will not immediately enter the “off” interval. Instead, the sound-type detector 404 remains active and continues to process the sound input and determine whether it corresponds to the predetermined type of sound. In some implementations, if the sound detector determines that the predetermined type of sound has been detected, it initiates the trigger sound detector 406 to further process the sound input and determine if the trigger sound has been detected.

Similar to the noise detector 402 and the sound-type detector 404, in some implementations, the trigger sound detector 406 operates according to a duty cycle. In some implementations, the trigger sound detector 406 is on for 50 milliseconds and off for 50 milliseconds. Other on and off durations are also possible. If the trigger sound detector 406 detects, during its “on” interval, that there is sound that may correspond to a trigger sound, the detector will not immediately enter the “off” interval. Instead, the trigger sound detector 406 remains active and continues to process the sound input and determine whether it includes the trigger sound. In some implementations, if such a sound is detected, the trigger sound detector 406 remains active to process the audio for a predetermined duration, such as 1, 2, 5, or 10 seconds, or any other appropriate duration. In some implementations, the duration is selected based on the length of the particular trigger word or sound that it is configured to detect. For example, if the trigger phrase is “Hey, Assistant,” the trigger word detector is operated for about 2 seconds to determine whether the sound input includes that phrase.

In some implementations, some of the sound detectors are operated according to a duty cycle, while others operate continuously when active. For example, in some implementations, only the first sound detector is operated according to a duty cycle (e.g., the noise detector 402 in FIG. 4), and upstream sound detectors are operated continuously once they are initiated. In some other implementations, the noise detector 402 and the sound-type detector 404 are operated according to a duty cycle, while the trigger sound detector 406 is operated continuously. Whether a particular sound detector is operated continuously or according to a duty cycle depends on one or more conditions, such as the context or operating state of a voice activated device. In some implementations, if a voice activated device is plugged in and not relying exclusively on battery power, all of the sound detectors operate continuously once they are initiated. In other implementations, the noise detector 402 (or any of the sound detectors) operates according to a duty cycle if the voice activated device is in a pocket or backpack (e.g., as determined by sensor and/or microphone signals), but operates continuously when it is determined that the voice activated device is likely not being stored. In some implementations, whether a particular sound detector is operated continuously or according to a duty cycle depends on the battery charge level of the voice activated device. For example, the noise detector 402 operates continuously when the battery charge is above 50%, and operates according to a duty cycle when the battery charge is below 50%.

In some implementations, the voice trigger includes noise, echo, and/or sound cancellation functionality (referred to collectively as noise cancellation). In some implementations, noise cancellation is performed by audio subsystem 214 (e.g., by an audio DSP). Noise cancellation reduces or removes unwanted noise or sounds from the sound input prior to it being processed by the sound detectors. In some cases, the unwanted noise is background noise from the user's environment, such as a fan or the clicking from a keyboard. In some implementations, the unwanted noise is any sound above, below, or at predetermined amplitudes or frequencies. For example, in some implementations, sound above the typical human vocal range (e.g., 3,000 Hz) is filtered out or removed from the signal. In some implementations, multiple microphones (e.g., the microphones 218) are used to help determine what components of received sound should be reduced and/or removed. For example, in some implementations, the audio subsystem 214 uses beam forming techniques to identify sounds or portions of sound inputs that appear to originate from a single point in space (e.g., a user's mouth). The audio subsystem 214 then focuses on this sound by removing from the sound input sounds that are received equally by all microphones (e.g., ambient sound that does not appear to originate from any particular direction).

In some implementations, the DSP is configured to cancel or remove from the sound input sounds that are being output by the voice activated device on which the digital assistant is operating. For example, if the audio subsystem 214 is outputting music, radio, a podcast, a voice output, or any other audio content (e.g., via the speaker 216), the DSP removes any of the outputted sound that was picked up by a microphone and included in the sound input. Thus, the sound input is free of the outputted audio (or at least contains less of the outputted audio). Accordingly, the sound input that is provided to the sound detectors will be cleaner, and the triggers more accurate. Aspects of noise cancellation are described in more detail in U.S. Pat. No. 7,272,224, which is hereby incorporated by reference in its entirety.

In some implementations, different sound detectors require that the sound input be filtered and/or preprocessed in different ways. For example, in some implementations, the noise detector 402 is configured to analyze time-domain audio signal between 60 and 20,000 Hz, and the sound-type detector is configured to perform frequency-domain analysis of audio between 60 and 3,000 Hz. Thus, in some implementations, an audio DSP of device 102 preprocesses received audio according to the respective needs of the sound detectors. In some implementations, on the other hand, the sound detectors are configured to filter and/or preprocess the audio from the audio subsystem 214 according to their specific needs. In such cases, the audio DSP may still perform noise cancellation prior to providing the sound input to the sound detectors.

In some implementations, the context of the voice activated device is used to help determine whether and how to operate the voice trigger. For example, it may be unlikely that users will invoke a speech-based service, such as a voice-based digital assistant, when the voice activated device is stored in their pocket, purse, or backpack. Also, it may be unlikely that users will invoke a speech-based service when they are listening to a loud rock concert. For some users, it is unlikely that they will invoke a speech-based service at certain times of the day (e.g., late at night). On the other hand, there are also contexts in which it is more likely that a user will invoke a speech-based service using a voice trigger. For example, some users will be more likely to use a voice trigger when they are alone, when they are at home, or the like. Various techniques are used to determine the context of a voice activated device. In various implementations, the voice activated device uses information from any one or more of the following components or information sources to determine the context of a voice activated device: light sensors, microphones, proximity sensors, motion sensors, cameras, communications circuitry and/or antennas, charging and/or power circuitry, temperature sensors, calendars, user preferences, etc.

The context of the voice activated device can then be used to adjust how and whether the voice trigger operates. For example, in certain contexts, the voice trigger will be deactivated (or operated in a different mode) as long as that context is maintained. For example, in some implementations, the voice trigger is deactivated when the voice activated device is unplugged, during predetermined time periods (e.g., between 10:00 PM and 8:00 AM), when the voice activated device is in a substantially enclosed space (e.g., a pocket, bag, purse, drawer, or glove box), when the voice activated device is near other devices that have a voice trigger and/or speech-based services (e.g., based on acoustic/wireless/infrared communications), and the like. In some implementations, instead of being deactivated, the voice trigger system 220 is operated in a low-power mode (e.g., by operating the noise detector 402 according to a duty cycle with a 10 millisecond “on” interval and a 5 second “off” interval). In some implementations, an audio channel is monitored more infrequently when the voice trigger system 220 is operated in a low-power mode. In some implementations, a voice trigger uses a different sound detector or combination of sound detectors when it is in a low-power mode than when it is in a normal mode. (The voice trigger may be capable of numerous different modes or operating states, each of which may use a different amount of power, and different implementations will use them according to their specific designs.)

On the other hand, when the voice activated device is in some other contexts, the voice trigger will be activated (or operated in a different mode) so long as that context is maintained. For example, in some implementations, the voice trigger remains active while it is plugged into a power source, during predetermined time periods (e.g., between 8:00 AM and 10:00 PM), when the voice activated device is travelling in a vehicle (e.g., based on GPS signals, BLUETOOTH connection or coupling with a vehicle, etc.), and the like. Aspects of determining when a device is in a vehicle are described in more detail in U.S. Provisional Patent Application No. 61/657,744, which is hereby incorporated by reference in its entirety. Several specific examples of how to determine certain contexts are provided below. In various embodiments, different techniques and/or information sources are used to detect these and other contexts.

As noted above, whether or not the voice trigger system 220 is active (e.g., listening) can depend on the physical orientation of a voice activated device. This provides a user with an easy way to activate and/or deactivate the voice trigger without requiring manipulation of switches or buttons. In some implementations, the voice activated device detects whether it is face-up or face-down on a surface using light sensors (e.g., based on the difference in incident light on a front and a back face of device 102), proximity sensors, cameras, and the like.

In some implementations, other operating modes, settings, parameters, or preferences are affected by the orientation and/or position of the voice activated device. In some implementations, the particular trigger sound, word, or phrase of the voice trigger is listening for depends on the orientation and/or position of the voice activated device. For example, in some implementations, the voice trigger listens for a first trigger word, phrase, or sound when the voice activated device is in one orientation (e.g., laying face-up on a surface), and a different trigger word, phrase, or sound when the voice activated device is in another orientation (e.g., laying face-down). In some implementations, the trigger phrase for a face-down orientation is longer and/or more complex than for a face-up orientation. Thus, a user can place a voice activated device face-down when they are around other people or in a noisy environment so that the voice trigger can still be operational while also reducing false accepts, which may be more frequent for shorter or simpler trigger words. As a specific example, a face-up trigger phrase may be “Hey, Assistant,” while a face-down trigger phrase may be “Hey, Assistant, this is Andrew, please wake up.” The longer trigger phrase also provides a larger voice sample for the sound detectors and/or voice authenticators to process and/or analyze, thus increasing the accuracy of the voice trigger and decreasing false accepts.

In some implementations, the voice activated device detects whether the voice activated device is stored (e.g., in a pocket, purse, bag, a drawer, or the like) by determining whether it is in a substantially enclosed space. In some implementations, the voice activated device uses light sensors (e.g., dedicated ambient light sensors and/or cameras) to determine that it is stored. For example, in some implementations, the voice activated device is likely being stored if light sensors detect little or no light. In some implementations, the time of day and/or location of the voice activated device are also considered. For example, if the light sensors detect low light levels when high light levels would be expected (e.g., during the day), the voice activated device may be in storage and the voice trigger system 220 not needed. Thus, the voice trigger system 220 will be placed in a low-power or standby state.

In some implementations, the difference in light detected by sensors located on opposite faces of a voice activated device can be used to determine its position, and hence whether or not it is stored. Specifically, users are likely to attempt to activate a voice trigger when the voice activated device is resting on a table or surface rather than when it is being stored in a pocket or bag. But when a voice activated device is lying face-down (or face-up) on a surface such as a table or desk, one surface of the voice activated device will be occluded so that little or no light reaches that surface, while the other surface will be exposed to ambient light. Thus, if light sensors on the front and back face of a voice activated device detect significantly different light levels, the voice activated device determines that it is not being stored. On the other hand, if light sensors on opposite faces detect the same or similar light levels, the voice activated device determines that it is being stored in a substantially enclosed space. Also, if the light sensors both detect a low light level during the daytime (or when the voice activated device would expect the phone to be in a bright environment), the voice activated device determines with a greater confidence that it is being stored.

In some implementations, other techniques are used (instead of or in addition to light sensors) to determine whether the voice activated device is stored. For example, in some implementations, the voice activated device emits one or more sounds (e.g., tones, clicks, pings, etc.) from a speaker or transducer (e.g., speaker 216), and monitors one or more microphones or transducers (e.g., microphone 218) to detect echoes of the omitted sound(s). (In some implementations, the voice activated device emits inaudible signals, such as sound outside of the human hearing range.) From the echoes, the voice activated device determines characteristics of the surrounding environment. For example, a relatively large environment (e.g., a room or a vehicle) will reflect the sound differently than a relatively small, enclosed environment (e.g., a pocket, purse, bag, a drawer, or the like).

In some implementations, the voice trigger system 220 operates differently if it is near other devices (such as other devices that have voice triggers and/or speech-based services) than if it is not near other devices. This may be useful, for example, to shut down or decrease the sensitivity of the voice trigger system 220 when many devices are close together so that if one person utters a trigger word, other surrounding devices are not triggered as well. In some implementations, a voice activated device determines proximity to other devices using RFID, near-field communications, infrared/acoustic signals, or the like.

Because people's voices vary greatly, it may be necessary or beneficial to tune a voice trigger to improve its accuracy in recognizing the voice of a particular user. Also, people's voices may change over time, for example, because of illnesses, natural voice changes relating to aging or hormonal changes, and the like. Thus, in some implementations, the voice trigger system 220 is able to adapt its voice and/or sound recognition profiles for a particular user or group of users.

As described above, sound detectors (e.g., the sound-type detector 404 and/or the trigger sound detector 406) may be configured to compare a representation of a sound input (e.g., the sound or utterance provided by a user) to one or more reference representations. For example, if an input representation matches the reference representation to a predetermined confidence level, the sound detector will determine that the sound input corresponds to a predetermined type of sound (e.g., the sound-type detector 404), or that the sound input includes predetermined content (e.g., the trigger sound detector 406). In order to tune the voice trigger system 220, in some implementations, the voice activated device adjusts the reference representation to which the input representation is compared. In some implementations, the reference representation is adjusted (or created) as part of a voice enrollment or “training” procedure, where a user outputs the trigger sound several times so that the voice activated device can adjust (or create) the reference representation. The voice activated device can then create a reference representation using that person's actual voice.

In some implementations, the voice activated device uses trigger sounds that are received under normal use conditions to adjust the reference representation. For example, after a successful voice triggering event (e.g., where the sound input was found to satisfy all of the triggering criteria) the voice activated device will use information from the sound input to adjust and/or tune the reference representation. In some implementations, only sound inputs that were determined to satisfy all or some of the triggering criteria with a certain confidence level are used to adjust the reference representation. Thus, when the voice trigger is less confident that a sound input corresponds to or includes a trigger sound, that voice input may be ignored for the purposes of adjusting the reference representation. On the other hand, in some implementations, sound inputs that satisfied the voice trigger system 220 to a lower confidence are used to adjust the reference representation.

In some implementations, device 102 iteratively adjusts the reference representation (using these or other techniques) as more and more sound inputs are received so that slight changes in a user's voice over time can be accommodated. For example, in some implementations, device 102 (and/or associated devices or services) adjusts the reference representation after each successful triggering event. In some implementations, device 102 analyzes the sound input associated with each successful triggering event and determines if the reference representations should be adjusted based on that input (e.g., if certain conditions are met), and only adjusts the reference representation if it is appropriate to do so. In some implementations, device 102 maintains a moving average of the reference representation over time.

In some implementations, the voice trigger system 220 detects sounds that do not satisfy one or more of the triggering criteria (e.g., as determined by one or more of the sound detectors), but that may actually be attempts by an authorized user to do so. For example, voice trigger system 220 may be configured to respond to a trigger phrase such as “Hey, Assistant,” but if a user's voice has changed (e.g., due to sickness, age, accent/inflection changes, etc.), the voice trigger system 220 may not recognize the user's attempt to activate the voice activated device. (This may also occur when the voice trigger system 220 has not been properly tuned for that user's particular voice, such as when the voice trigger system 220 is set to default conditions and/or the user has not performed an initialization or training procedure to customize the voice trigger system 220 for his or her voice.) If the voice trigger system 220 does not respond to the user's first attempt to active the voice trigger, the user is likely to repeat the trigger phrase. The voice activated device detects that these repeated sound inputs are similar to one another, and/or that they are similar to the trigger phrase (though not similar enough to cause the voice trigger system 220 to activate the speech-based service). If such conditions are met, the voice activated device determines that the sound inputs correspond to valid attempts to activate the voice trigger system 220. Accordingly, in some implementations, the voice trigger system 220 uses those received sound inputs to adjust one or more aspects of the voice trigger system 220 so that similar utterances by the user will be accepted as valid triggers in the future. In some implementations, these sound inputs are used to adapt the voice trigger system 220 only if a certain conditions or combinations of conditions are met. For example, in some implementations, the sound inputs are used to adapt the voice trigger system 220 when a predetermined number of sound inputs are received in succession (e.g., 2, 3, 4, 5, or any other appropriate number), when the sound inputs are sufficiently similar to the reference representation, when the sound inputs are sufficiently similar to each other, when the sound inputs are close together (e.g., when they are received within a predetermined time period and/or at or near a predetermined interval), and/or any combination of these or other conditions.

While the adaptation techniques described above refer to adjusting a reference representation, other aspects of the trigger sound detecting techniques may be adjusted in the same or similar manner in addition to or instead of adjusting the reference representation. For example, in some implementations, the voice activated device adjusts how sound inputs are filtered and/or what filters are applied to sound inputs, such as to focus on and/or eliminate certain frequencies or ranges of frequencies of a sound input. In some implementations, the voice activated device adjusts an algorithm that is used to compare the input representation with the reference representation. For example, in some implementations, one or more terms of a mathematical function used to determine the difference between an input representation and a reference representation are changed, added, or removed, or a different mathematical function is substituted.

In some implementations, adaptation techniques such as those described above require more resources than the voice trigger system 220 is able to or is configured to provide. In particular, the sound detectors may not have, or have access to, the amount or the types of processors, data, or memory that are necessary to perform the iterative adaptation of a reference representation and/or a sound detection algorithm (or any other appropriate aspect of the voice trigger system 220). Thus, in some implementations, one or more of the above described adaptation techniques are performed by a more powerful processor, such as an application processor (e.g., the processor(s) 204), or by a different device (e.g., the server system 108). However, the voice trigger system 220 is designed to operate even when the application processor is in a standby mode. Thus, the sound inputs which are to be used to adapt the voice trigger system 220 are received when the application processor is not active and cannot process the sound input. Accordingly, in some implementations, the sound input is stored by the voice activated device so that it can be further processed and/or analyzed after it is received. In some implementations, the sound input is stored in system memory (e.g., memory 206, FIG. 2) using direct memory access (DMA) techniques (including, for example, using a DMA engine so that data can be copied or moved without requiring the application processor to be initiated). The stored sound input is then provided to or accessed by the application processor (or the server system 108, or another appropriate device) once it is initiated so that the application processor can execute one or more of the adaptation techniques described above. In some implementations,

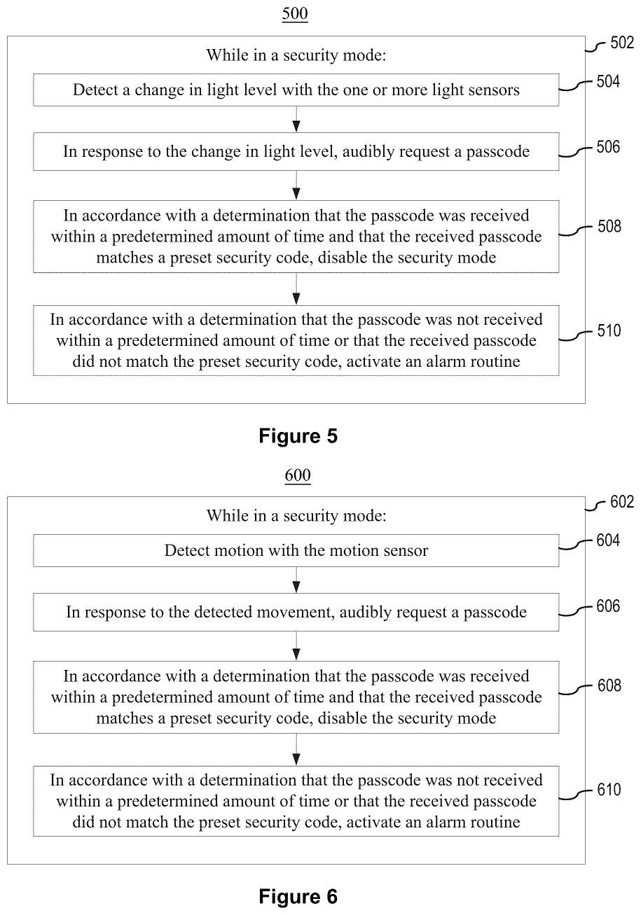

FIGS. 5-6 are flow diagrams representing methods for operating a voice activated device in a security mode, according to certain implementations. The methods are, optionally, governed by instructions that are stored in a computer memory or non-transitory computer readable storage medium (e.g., memory 206 of device 102, memory 302 associated with the digital assistant system 300) and that are executed by one or more processors of one or more computer systems of a digital assistant system, including, but not limited to, server system 108, and/or voice activated device 102. The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various implementations, some operations in each method may be combined and/or the order of some operations may be changed from the order shown in the figures. Also, in some implementations, operations shown in separate figures and/or discussed in association with separate methods may be combined to form other methods, and operations shown in the same figure and/or discussed in association with the same method may be separated into different methods. Moreover, in some implementations, one or more operations in the methods are performed by modules of the digital assistant system 300 and/or an electronic device (e.g., the voice activated device 102), including, for example, the natural language processing module 332, the dialogue flow processing module 334, the audio subsystem 214, the noise detector 402, the sound-type detector 404, the trigger sound detector 406, the speech-based service 408, and/or any sub modules thereof.

FIG. 5 illustrates a method 500 of operating a voice activated device (e.g., voice activated device 102, FIG. 2) in a security mode, according to some implementations. While in a security mode (502), the voice activated device detects (504) a change in light level with the one or more light sensors. In some embodiments, detecting the change in the light level includes detecting an increase in light level (e.g., with light sensor 234) above a predefined threshold. In some embodiments, detecting the change in the light level includes detecting a decrease in light level (e.g., with light sensor 234) below a predefined threshold.

In response to the change in light level, the voice activated device audibly requests (506) a passcode. For example, the voice activated device prompts the user (e.g., using speaker 216) to speak a preset password which will be captured by microphone 218.

In accordance with a determination that the passcode was received within a predetermined amount of time (e.g., 0.5, 1, 5, 10, 20 seconds or another reasonable time period) and that the received passcode matches a preset security code, the voice activated device disables (508) the security mode. For example, the user speaks the passcode within a predetermined amount of time and the voice activated device verifies the passcode then enters a default or preset mode.

In accordance with a determination that the passcode was not received within a predetermined amount of time or that the received passcode did not match the preset security code, the voice activated device activates (510) an alarm routine. In some implementations, activating the alarm routine includes notifying the police that an intruder is preset. In some implementations, activating the alarm routine includes playing an audile alarm. In some implementations, activating the alarm routine includes sending an alert notification to coupled devices. In some implementations, activating the alarm routine includes locking all coupled devices.

FIG. 6 illustrates a method 600 of operating a voice activated device (e.g., voice activated device 102, FIG. 2) in a security mode, according to some implementations. While in a security mode (602), the voice activated device detects (604) movement with the motion sensor. For example, the voice activated device detects a person entering the room.

In response to the detected movement, the voice activated device audibly requests (606) a passcode. In accordance with a determination that the passcode was received within a predetermined amount of time (e.g., 0.5, 1, 5, 10, 20 seconds or another reasonable time period) and that the received passcode matches a preset security code, the voice activated device disables (608) the security mode. In accordance with a determination that the passcode was not received within a predetermined amount of time or that the received passcode did not match the preset security code, the voice activated device activates 610) an alarm routine. In some implementations, activating the alarm routine includes notifying the police that an intruder is preset. In some implementations, activating the alarm routine includes playing an audile alarm. In some implementations, activating the alarm routine includes sending an alert notification to coupled devices. In some implementations, the voice activated device is coupled to a plurality of user devices and activating the alarm routine includes locking at least a subset of the coupled devices.

The foregoing description, for purpose of explanation, has been described with reference to specific implementations. However, the illustrative discussions above are not intended to be exhaustive or to limit the disclosed implementations to the precise forms disclosed. Many modifications and variations are possible in view of the above teachings. The implementations were chosen and described in order to best explain the principles and practical applications of the disclosed ideas, to thereby enable others skilled in the art to best utilize them with various modifications as are suited to the particular use contemplated.

It will be understood that, although the terms “first,” “second,” etc. may be used herein to describe various elements, these elements should not be limited by these terms. These terms are only used to distinguish one element from another. For example, a first sound detector could be termed a second sound detector, and, similarly, a second sound detector could be termed a first sound detector, without changing the meaning of the description, so long as all occurrences of the “first sound detector” are renamed consistently and all occurrences of the “second sound detector” are renamed consistently. The first sound detector and the second sound detector are both sound detectors, but they are not the same sound detector.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “upon a determination that” or “in response to determining” or “in accordance with a determination” or “upon detecting” or “in response to detecting” that the stated condition precedent is true, depending on the context.

1. (canceled)

2. A voice activated device, comprising, one or more processors;
a microphone;
a noise detector;
a sound-type detector;
a trigger sound detector; and
memory storing one or more programs configured to be executed by the one or more processors, the one or more programs including instructions for:
receiving a first audio spoken by a user;
determining, using the noise detector, whether the received first audio satisfies a first predetermined condition;
in accordance with a determination that the first predetermined condition is satisfied:
initiating the sound-type detector;
determining, using the sound-type detector, whether the received first audio satisfies a second predetermined condition;
in accordance with a determination that the second predetermined condition is satisfied:
initiating the trigger sound detector;
determining, using the trigger sound detector, whether the received first audio satisfies a third predetermined condition;
in accordance with a determination that the third predetermined condition is satisfied:
causing speech recognition to be performed to identify a user request from the received first audio.

3. The voice activated device of claim 2, wherein the first predetermined condition is satisfied when the received first audio is above a threshold volume for a predetermined amount of time.

4. The voice activated device of claim 2, wherein the first predetermined condition is satisfied when the voice activated device determines the voice activated device is not stored in an enclosed space.

5. The voice activated device of claim 2, wherein the noise detector uses time-domain analysis of the received first audio to determine whether the received first audio satisfies the first predetermined condition.

6. The voice activated device of claim 2, wherein the noise detector requires fewer computational and battery resources than the sound detector.

7. The voice activated device of claim 2, wherein the sound-type detector uses frequency-domain analysis of the received first audio to determine whether the received first audio satisfies the second predetermined condition.

8. The voice activated device of claim 2, wherein the second predetermined condition is satisfied when the received first audio corresponds to a predetermined type of sound.

9. The voice activated device of claim 8, wherein the predetermined type of sound includes a human speech type of sound.

10. The voice activated device of claim 2, wherein the third predetermined condition is satisfied when a representation of the received first audio matches at least one of one or more reference representations of a trigger word.

11. The voice activated device of claim 10, wherein determining whether the received first audio satisfies a third predetermined condition includes:
comparing, using the trigger sound detector, the representation of the received first audio to the one or more reference representations of the trigger word.

12. The voice activated device of claim 10, wherein the one or more reference representations include one or more spectrograms, and wherein the one or more spectrograms represent how one or more spectral densities of one or more signals vary with time.

13. The voice activated device of claim 2, wherein causing speech recognition to be performed to identify the user request from the received first audio includes:
causing voice authentication to be performed to determine if the received first audio corresponds to a voice of a particular person.

14. The voice activated device of claim 2, wherein the sound-type detector remains active while the first predetermined condition is satisfied.

15. The voice activated device of claim 2, wherein the trigger sound detector remains active while the first predetermined condition is satisfied.

16. The voice activated device of claim 2, wherein the trigger sound detector remains active while the second predetermined condition is satisfied.

17. The voice activated device of claim 2, wherein the one or more programs further include instructions for:
in response to initiating the trigger sound detector:
deactivating the noise detector and the sound-type detector.

18. A method, comprising:
at a voice activated device with a microphone:
receiving a first audio spoken by a user;
determining, using a noise detector, whether the received first audio satisfies a first predetermined condition;
in accordance with a determination that the first predetermined condition is satisfied:
initiating a sound-type detector;
determining, using the sound-type detector, whether the received first audio satisfies a second predetermined condition;
in accordance with a determination that the second predetermined condition is satisfied:
initiating a trigger sound detector;
determining, using the trigger sound detector, whether the received first audio satisfies a third predetermined condition;
in accordance with a determination that the third predetermined condition is satisfied:
causing speech recognition to be performed to identify a user request from the received first audio.

19. A non-transitory computer-readable storage medium storing one or more programs, wherein the one or more programs include instructions, which when executed by one or more processors of a voice activated device with a microphone, cause the voice activated device to:
receive a first audio spoken by a user;
determine, using the noise detector, whether the received first audio satisfies a first predetermined condition;
in accordance with a determination that the first predetermined condition is satisfied:
initiate the sound-type detector;
determine, using the sound-type detector, whether the received first audio satisfies a second predetermined condition;
in accordance with a determination that the second predetermined condition is satisfied:
initiate the trigger sound detector;
determine, using the trigger sound detector, whether the received first audio satisfies a third predetermined condition;
in accordance with a determination that the third predetermined condition is satisfied:
cause speech recognition to be performed to identify a user request from the received first audio.
